(19) United States
(12) Patent Application Publication
(10) Pub. No.: US 2012/0215481 A1
(43) Pub. Date: Aug. 23, 2012

(54) METHODS AND APPARATUS RELATED TO MANAGEMENT OF EXPERIMENTS

(75) Inventors: Todd M. Covey, San Carlos, CA (US); Darwin A. Farrow, Castro Valley, CA (US); Barton J. Friedland, San Francisco, CA (US); Helen Francis-Lang, Deven (GB); Malcolm Francis-Lang, Devon (GB); Justin W. Mccarthy, San Francisco, CA (US); Norman B. Purvis, JR., Franklin, TN (US); Santosh K. Putta, Foster City, CA (US); David B. Rosen, Mountain View, CA (US); David M. Soper, San Francisco, CA (US); David C. Spellmeyer, Oakland, CA (US)

(73) Assignee: Nodality, Inc., South San Francisco, CA (US)

(21) Appl. No.: 13/399,489

(22) Filed: Feb. 17, 2012

Related U.S. Application Data
(63) Continuation of application No. 12/501,274, filed on Jul. 10, 2009, now abandoned.
(60) Provisional application No. 61/079,551, filed on Jul. 10, 2008.
(60) Provisional application No. 61/087,555, filed on Aug. 8, 2008.
(60) Provisional application No. 61/153,627, filed on Feb. 18, 2009.
(60) Provisional application No. 61/079,537, filed on Jul. 10, 2008.

(51) Int. Cl. G06F 19/00

(52) U.S. Cl. 702/123

(57) ABSTRACT

In one embodiment, a method includes sending an indicator of an availability of a sample from a sample pool stored in a physical inventory. The sample being included in the sample pool based on an attribute of the sample satisfying a condition associated with the sample pool. An indicator that the sample has been selected from the sample pool for analysis at a first test site included in an array of test sites is received. A rule is retrieved from a rule database based on an experimental parameter value associated with the first test site. At least one of the experimental parameter value associated with the first test site or an experimental parameter value associated with a second test site is modified based on a condition within the rule being satisfied.

### RELATED APPLICATIONS

This application is a continuation of U.S. patent application Ser. No. 12/501,274, filed on Jul. 10, 2009, entitled “Methods and Apparatus Related to Management of Experiments,” which claims priority to and the benefit of U.S. Provisional Patent Application No. 61/079,551, filed on Jul. 10, 2008, entitled “Systems and Methods for Experimental Design, Layout and Inventory Management”; U.S. Provisional Patent Application No. 61/087,555, filed on Aug. 8, 2008, entitled “System and Method for Providing a Bioinformatics Database”; U.S. Provisional Patent Application No. 61/153,627, filed on Feb. 18, 2009, entitled “Methods and Apparatus Related to Management of Experiments”; and U.S. Provisional Patent Application No. 61/079,537, filed on Jul. 10, 2008, entitled “Method and System for Data Extraction and Visualization of Multi-Parametric Data”; each of which is incorporated herein by reference in its entirety.

### BACKGROUND

Embodiments described herein relate generally to methods and apparatus for management of experiments.

Research in many fields such as molecular biology, biochemistry, can require organization and analysis of complex experiments that involve many variables, such as, various equipments types with different limitations, numerous reactants that may have subtle incompatibilities, intricate testing and preparation procedures, and so forth. Known techniques for defining and organizing these types of complex experiments can be relatively inefficient, inaccurate, and unscalable. In addition, analyzing data produced by these complex experiments based on known techniques can be difficult. Thus, a need exists for methods and apparatus to address the shortfalls of present technology and to provide other new and innovative features.

### SUMMARY

In one embodiment, a method includes sending an indicator of an availability of a sample from a sample pool stored in a physical inventory. The sample being included in the sample pool based on an attribute of the sample satisfying a condition associated with the sample pool. An indicator that the sample has been selected from the sample pool for analysis at a first test site included in an array of test sites is received. A rule is retrieved from a rule database based on an experimental parameter value associated with the first test site. At least one of the experimental parameter value associated with the first test site or an experimental parameter value associated with a second test site is modified based on a condition within the rule being satisfied.

### BRIEF DESCRIPTION OF THE DRAWINGS

FIG. 1 is a schematic block diagram that illustrates an experiment management engine configured to define and send an experiment file to a test device, according to an embodiment.

FIG. 2 is a schematic block diagram that illustrates components within an experiment management engine, according to an embodiment.

FIG. 3 is a schematic diagram that illustrates an inventory database, according to an embodiment.

FIG. 4 is a schematic diagram that illustrates an experiment template, according to an embodiment.

FIG. 5 is a schematic block diagram that illustrates rules that can be used to define experimental parameter values, according to an embodiment.

FIG. 6 is a flowchart that illustrates a method for defining an experiment file at an experiment management engine, according to an embodiment.

FIG. 7 is a diagram that illustrates an example of a portion of a workflow 700, according to an embodiment.

FIG. 8 is a schematic diagram that illustrates data relationships that can be managed at an experiment management engine, according to an embodiment.

FIG. 9 is a schematic diagram that illustrates indicator layers associated with a test substrate, according to an embodiment.

FIG. 10 is a schematic diagram that illustrates hierarchically related testing substrates and test substances, according to an embodiment.

FIG. 11 is a schematic block diagram that illustrates samples included in sample pools, according to an embodiment.

FIG. 12 is a flowchart that illustrates a method for processing a sample associated with a sample pool, according to an embodiment.

FIG. 13 is a schematic block diagram that illustrates a matrix of test sites of a testing substrate, according to an embodiment.

FIG. 14 is a flowchart that illustrates a method for performing a fall-off calculation, according to an embodiment.

FIG. 15 is a screenshot of a graphical user interface related to database management, according to an embodiment.

FIG. 16 is a screenshot of a graphical user interface related to experimental design, according to an embodiment.

FIG. 17 is a screen shot of another graphical user interface related to experimental design, according to an embodiment.

FIG. 18 is a screenshot of a graphical user interface illustrating a color code feature, according to an embodiment.

FIG. 19 is a flowchart that illustrates a method for designing an experiment, according to an embodiment.

FIG. 20 is a schematic diagram that illustrates a visualization module of an experiment management engine configured to trigger display of values within a user interface, according to an embodiment.

FIG. 21 is a schematic diagram that illustrates a method for displaying output data within a visualization layout, according to an embodiment.

### DETAILED DESCRIPTION

An experiment management engine can be configured to manage processing related to one or more experiments. An experiment (e.g., a research experiment, a drug screening experiment, a diagnostic experiment) can include processing (e.g., testing, diagnostic testing) of a substance (e.g., a sample such as a biological sample and/or a reagent configured to stimulate the sample) at a test device and/or preparation of the substance for processing at the test device. The test device can be, for example, a stress test device, a flow cytometer (e.g., a four-color fluorescence capable flow cytometer such as a FACScalibur flow cytometer, or higher color capability flow cytometers, such and LSR II or FACS Canto II), a mass spectrometer (e.g., an inductively coupled plasma mass spectrometer (ICP-MS) device such as a PerkinElmer SCIEX), a device configured to test various assays (Enzyme Linked Immuno-Sorbent Assays (ELISA), protein and cell growth assays, assays for molecular interactions, enzyme activity assays, cell toxicity assays, immunoassays, and high throughput screening of compounds and targets in drug discovery such as FLIPR assays), and so forth. In some embodiments, any portion of a substance (e.g., a material) to be used during an experiment (e.g., during preparation, during testing at a test device, a quality control portion of an experiment) can be referred to as a test substance (or test material) or as a target substance (or target material). In some embodiments, the experiment management engine can be included in an experiment system.

Several factors to understand and/or control when addressing the utility (e.g., clinical utility) of an experimental design are: clinical intervention points, clinical need (through experimental planning), control/tracking of reagent/sample quality, control/monitoring instrumentation (e.g., test devices), gate (e.g., gate boundary) stability, quantitation of sample (e.g., cellular, rare cellular) populations, data organization, application of appropriate metrics, data integrity, statistical design and execution, disease characterization, visualization of high dimensional data, and network effects. Control/tracking of reagent/sample quality can be related to comparisons of results across laboratories across time, an understanding of variables related to reagents (e.g., vendor qualifications, ideal concentrations, limitations), and/or so forth. Control/monitoring of instrumentation can be related to instrumentation reproducibility, intra- and inter-laboratory compatibility, issues related to operator variability, consistency of instrumentation (e.g., instrumentation settings), and/or so forth. Gating stability can be related to methods of highlighting gating robustness and/or tracking metrics (e.g., downstream metrics, relative metrics). Quantitation of sample populations can be related to identification of sample populations (through alerts), estimating usage of sample populations, gating related to sample populations, and/or so forth. Data organization can be related to scaling of experimentation, tracking of data for quality assurance (QA) and quality control (QC), tracking of data across many variables (e.g., experiments, time, sites, patients), and/or so forth. More details related to gating are described in co-pending U.S. patent application bearing attorney docket no. NODA-002/01US 309855-2006, filed on Jul. 10, 2009, entitled, “Methods and Apparatus Related to Gate Boundaries within a Data Space,” and co-pending U.S. Patent Application No. 61/079,579, filed on Jul. 10, 2008, entitled “Gating Sensitivity Data Analysis,” both of which are incorporated herein by reference in their entireties.

Decisions and/or planning related to many of the factors identified above can be facilitated through the functions of the experiment management engine. For example, the experiment management engine can be configured to define (e.g., calculate, modify) one or more experimental parameter values related to a design/layout of an experiment, manage workflows (e.g., complicated workflows) related to processing and/or preparation of a test substance during an experiment, track/order test substances included in an inventory (e.g., a physical inventory), and so forth. These functions can be integrated at the experiment management engine so that the experiment management engine, for example, can be scaled in a desirable fashion and can facilitate relatively high utilization rates for one or more test devices. The experiment management engine also can be configured to assist in designing experiments in an efficient fashion so that duplication of effort and wastage of materials can be avoided. In other words, the experiment management engine can be configured to integrate information from multiple systems, antibody databases, test device (e.g., cytometer instrument) configurations, user-implemented rules, user-defined experimental templates and designs, antibody recommendation tables and/or so forth. Based on this integrated information, the experiment management engine can be configured to, for example, provide suggestions to a user and/or notify a user about potential issues related to their experimental plan while still providing the user with total control over experimental design and/or the ability to override control over the experiment management engine.

The following publications are hereby incorporated by reference in this patent application in their entireties:
Haskell et al., Cancer Treatment, 5^{th} Ed., W.B. Saunders and Co., 2001;
Alberts et al., The Cell, 4th Ed., Garland Science, 2002;
Vogelstein and Kinzler, The Genetic Basis of Human Cancer, 2d Ed., McGraw Hill, 2002;
Michael, Biochemical Pathways, John Wiley and Sons, 1999;
Weinberg, The Biology of Cancer, 2007; Immunobiology, Janeway et al. 7th Ed.;
Garland, Leroith and Bondy, Growth Factors and Cytokines in Health and Disease, A Multi Volume Treatise, Volumes 1A and IB, Growth Factors, 1996;
Shapiro, Howard M., Practical Flow Cytometry, 4th Ed., John Wiley & Sons, Inc., 2003;
H. Rashidi and K. Buehler, Bioinformatics Basics: Applications in Biological Science and Medicine (CRC Press, London, 2000);
Bioinformatics: A Practical Guide to the Analysis of Genes and Proteins (B. F. Ouelette and A. D. Baxevanis, eds., Wiley & Sons, Inc.; 2d ed., 2001);
High-content single-cell drug screening with phosphospecific flow cytometry, Krutzik et al., Nature Chemical Biology, 23 Dec. 2007;
Irish et al., Flt3 Y591 duplication and Bcl-2 over expression are detected in acute myeloid leukemia cells with high levels of phosphorylated wild-type p53, Neoplasia, 2007;
Irish et al. Mapping normal and cancer cell signaling networks: towards single-cell proteomics, Nature, Vol. 6 146-155, 2006;
Irish et al., Single cell profiling of potentiated phospho-protein networks in cancer cells, Cell, Vol. 118, 1-20 Jul. 23, 2004;
Schulz, K. R., et al., Single-cell phospho-protein analysis by flow cytometry, Curr Protoc Immunol, 2007, 78:8 8.17.1-20;
Krutzik, P. O., et al., Coordinate analysis of murine immune cell surface markers and intracellular phosphoproteins by flow cytometry, J. Immunol. 2005 Aug. 15, 175(4):2357-65;
Krutzik, P. O., et al., Characterization of the murine immunological signaling network with phosphospecific flow cytometry, J. Immunol. 2005 Aug. 15, 175(4):2366-73;
Shulz et al., Current Protocols in Immunology 2007, 78:8.17.1-20;
Stelzer et al., Use of Multiparameter Flow Cytometry and Immunophenotyping for the Diagnosis and Classfication of Acute Myeloid Leukemia, Immunophenotyping, Wiley, 2000; and
Krutzik, P. O. and Nolan, G. P., Intracellular phospho-protein staining techniques for flow cytometry: monitoring single cell signaling events, Cytometry A. 2003 Oct. 55(2):61-70.

The following patents are hereby incorporated by reference in this patent application in their entireties: U.S. Pat. No. 7,381,535 and U.S. Pat. No. 7,393,656. The following patent applications are also hereby incorporated by reference in this patent application in their entireties: U.S. Ser. No. 10/193,462; U.S. Ser. No. 11/655,785; U.S. Ser. No. 11/655,789; U.S. Ser. No. 11/655,821; U.S. Ser. No. 11/338,957; U.S. Ser. No. 61/048,886; U.S. Ser. No. 61/048,920; U.S. Ser. No. 61/048,657; U.S. Ser. No. 61/079,766; U.S. Ser. No. 61/079,579; and U.S. Ser. No. 61/079,537.

Some commercial reagents, protocols, software and instruments that can be used in at least some of the embodiments described herein can be accessed at the Becton Dickinson website at http://www.bdbiosciences.com/features/products/, the Beckman Coulter website at http://www.beckmancoulter.com/Default.asp?bhfv=7, and Cell Signaling Technology's website at http://www.cellsignal.com. Experimental and process protocols and other information can be found at http://proteomics.stanford.edu and http://facs.stanford.edu.

As used in this application, the singular forms “a,” “an,” and “the” include plural references unless the context clearly dictates otherwise. For example, the term “a biological sample” includes a plurality of biological samples, including mixtures thereof. In some embodiments, an individual is not limited to a human being but may also be other organisms including, but not limited to mammals, plants, bacteria, or cells derived from any of the above.

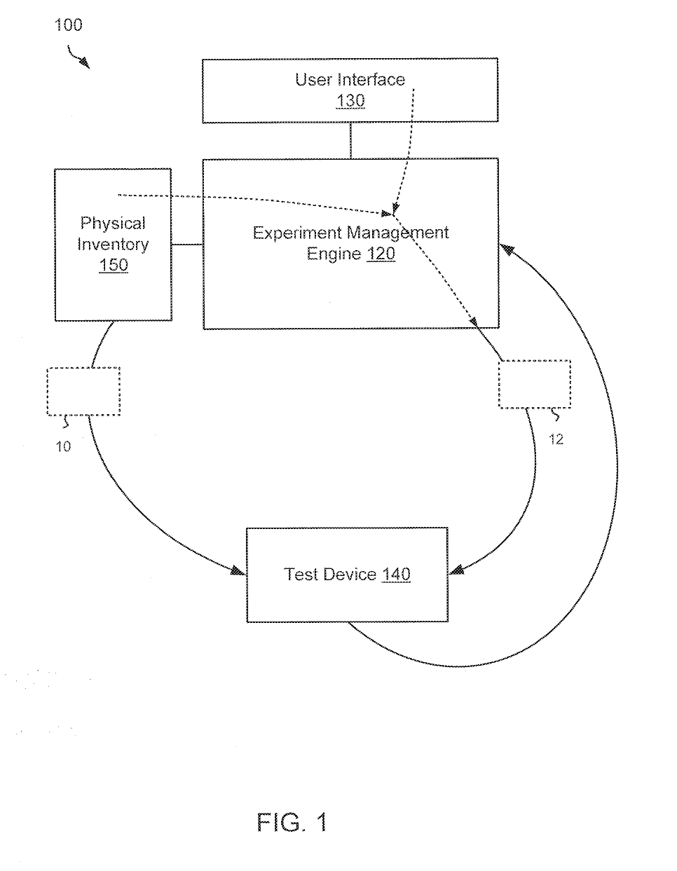

FIG. 1 is a schematic block diagram that illustrates an experiment management engine 120 configured to facilitate execution of an experiment, according to an embodiment. The experiment (also can be referred to as an experimental plan) can include a preparation phase, a processing phase, and an analysis phase. In some embodiments, the analysis phase can include processing and display of output data in, for example, a visualization layout. In some embodiments, the experiment can be managed based on a workflow. As shown in FIG. 1, the experiment management engine 120 can be included in an experiment system 100, which also includes a user interface 130 and a physical inventory 150.

During the preparation phase, a testing procedure can be defined based on, for example, a clinical study, drug screening, diagnostic analysis or research. A test substance 10 from the physical inventory 150 can be prepared for processing at a test device 140 based on the testing procedure. In some embodiments, the test substance 10 can be included in (e.g., disposed on top of contained within) a testing substrate (not shown) such as a slide, a plate (e.g., a 96 well plate, a 384 well plate, a microtiter plate, a deep-well plate, a square plate), a platform with various volumes, a solid-phase matrix, a tray, a container (such as a test tube, a multi-tube, a mini-tube, a microfuge tube, a cryovial), and/or a well (e.g., a well capable of holding liquid) that can be used to facilitate processing of the test substance 10 at the test device 140. Also during the preparation phase, the experiment management engine 120 can be configured to define an experiment file 12 that can be sent to (e.g., transmitted to), for example, a test module (not shown) of the test device 140. The experiment file 12 can include instructions related to the testing procedure. In some embodiments, an experiment can be related to, for example, a single well (which can be a sub-experiment) and/or many plates. In some embodiments, an experiment file can be referred to as an instruction file.

During the processing phase, the test substance 10 can be processed (e.g., tested, analyzed, modified) at the test device 140 based on the experiment file 12. In other words, the experiment file 12 can be configured to provide to the test device 140 some, most, or all of the information required by the test device 140 to process the test substance 10 (e.g., process the test substance 10 based on a testing procedure), and optionally, to cause the test device 140 to initiate processing. In some embodiments, the processing performed at the test device 140 can be referred to as a processing procedure or as testing procedure.

Finally, during the analysis phase, data (e.g., output data) produced based on the processing of the test substance 10 at the test device 140 and/or experimental parameter values (e.g., hidden experimental parameter values, unhidden experimental parameter values) communicated in the experiment file 12 can be analyzed (e.g., statistically analyzed, used in calculation to define metrics, correlated to clinical outcomes, analyzed based on gating techniques (also can be referred to as gate boundary techniques)). In some embodiments, the analysis can be performed at the test device 140 or analyzed at a different device (not shown) such as a computing device based on one or more portions of the experiment file 12. Although described as different phases, in some embodiments, portions of these phases can be performed simultaneously, or in a different order.

In some embodiments, the test substance 10 can include one or more samples (e.g., a single sample, a combination of samples) that are a target of processing at the test device 140, and/or one or more reagents. In some embodiments, the sample can be, for example, a biological sample (e.g., a blood sample or fraction thereof, bone marrow, a tissue sample). In some embodiments, the sample can be, for example, a chemical sample (e.g., a chemical compound such as an anticancer drug) that is not a biological sample and/or is not organic in nature. In some embodiments, the test substance 10 can be one or more samples not combined with a reagent.

A reagent included in the test substance 10 can be configured (e.g., formulated) to influence processing of the sample at the test device 140. The reagent can be, for example, a stimulant/modulator (e.g., a modulator configured to activate an activatable pathway in a cell), a detection element (e.g., an antibody coupled to a fluorescent label, a stain), an antibody, a buffer, and so forth. For example, in some embodiments, the reagent can be included in the test substance 10 so that a characteristic of the sample included in the test substance 10 can be detected in a desirable fashion when the test substance 10 is being processed at the test device 140. More details related to reagents are set forth in the '551 application.

A modulator can be, for example, one or more of growth factors, cytokines, adhesion molecules, drugs, hormones, small molecules, polynucleotides, antibodies, natural compounds, lactones, chemotherapeutic agents, immune modulators, carbohydrates, proteases, ions, reactive oxygen species, peptides, and protein fragments, either alone or in the context of cells, cells themselves, viruses, and biological and non-biological complexes (e.g. beads, plates, viral envelopes, antigen presentation molecules such as major histocompatibility complex) F(ab)2 IgM, H202, PMA, BAFF, April, SDF 1a, CD40L, IGF-1, Imiquimod, polyCpG, IL-7. In another embodiment, the modulator is a inhibitor selected from the group consisting of H202, siRNA, miRNA, Cantharidin, (−)-p-Bromotetramisole, Microcystin LR, Sodium Orthovanadate, Sodium Pervanadate, Vanadyl sulfate, Sodium oxodiperoxo(1,10-phenanthroline)vanadate, bis(maltolato)oxovanadium(IV), Sodium Molybdate, Sodium Penn olybdate, Sodium Tartrate, Imidazole, Sodium Fluoride, PGlycerophosphate, Sodium Pyrophosphate Decahydrate, Calyculin A, Discodermia calyx, bpV(phen), mpV(pic), DMHV, Cypermethrin, Dephostatin, Okadaic Acid, NIPP-1, N-(9,10-Dioxo-9,10-dihydro-phenanthren-2-yl)-2,2-dimethyl-pr0pi0namidae-B, romo-4-hydroxyacetophenone, 4-Hydroxyphenacyl Br, a-Bromo-4-methoxyacetophenone, 4-Methoxyphenacyl Br, a-Bromo-4-(carboxymethoxy)acetophenone, 4-(Carboxymethoxy)phenacyl Br, and bis(4-Trifluoromethylsulfonamidophenyl)-1,4-diisopropylbenzene, phenyarsine oxide, Pyrrolidine Dithiocarbamate, and Aluminium fluoride, kinases, phosphatases, lipid signaling molecules, adaptorlscaffold proteins, cytokines, cytokine regulators, ubiquitination enzymes, adhesion molecules, cytoskeletal/contractile proteins, heterotrimeric G proteins, small molecular weight GTPases, guanine nucleotide exchange factors, GTPase activating proteins, caspases, proteins involved in apoptosis, cell cycle regulators, molecular chaperones, metabolic enzymes, vesicular transport proteins, hydroxylases, isomerases, deacetylases, methylases, demethylases, tumor suppressor genes, proteases, ion channels, molecular transporters, transcription factors 1 DNA binding factors, regulators of transcription, and regulators of translation. In another embodiment, the activatable elements are selected from the groups consisting of HER receptors, PDGF receptors, Kit receptor, FGF receptors, Eph receptors, Trk receptors, IGF receptors, Insulin receptor, Met receptor, Ret, VEGF receptors, TIE1, TIE2, FAK, Jak1, Jak2, Jak3, Tyk2, Src, Lyn, Fyn, Lck, Fgr, Yes, Csk, Abl, Btk, ZAP70, Syk, IRAKs, cRaf, ARaf, BRAF, Mos, Lim kinase, ILK, Tpl, ALK, TGFP receptors, BMP receptors, MEKKs, ASK, MLKs, DLK, PAKs, Mek 1, Mek 2, MKK316, MKK417, ASK1, Cot, NIK, Bub, Myt 1, Weel, Casein kinases, PDK1, SGK1, SGK2, SGK3, Akt1, Akt2, Akt3, p90Rsks, p70S6Kinase, Prks, PKCs, PKAs, ROCK 1, ROCK 2, Auroras, CaMKs, MNKs, AMPKs, MELK, MARKS, Chk1, Chk2, LKB-1, MAPKAPKs, Pim1, Pim2, Pim3, IKKs, Cdks, Jnks, Erks, IKKs, GSK3a, GSK3P, Cdks, CLKs, PKR, P13-Kinase class 1, class 2, class 3, mTor, SAPWJNK1,2,3, p38s, PKR, DNA-PK, ATM, ATR, Receptor protein tyrosine phosphatases (RPTPs), LAR phosphatase, CD45, Non receptor tyrosine phosphatases (NPRTPs), SHPs, MAP kinase phosphatases (MKPs), Dual Specificity phosphatases (DUSPs), CDC25 phosphatases, Low molecular weight tyrosine phosphatase, Eyes absent (EYA) tyrosine phosphatases, Slingshot phosphatases (SSH), serine phosphatases, PP2A, PP2B, PP2C, PP1, PPS, inositol phosphatases, PTEN, SHIPS, myotubularins, phosphoinositide kinases, phopsholipases, prostaglandin synthases, 5-lipoxygenase, sphingosine kinases, sphingomyelinases, adaptorlscaffold proteins, She, Grb2, BLNK, LAT, B cell adaptor for P13-kinase (BCAP), SLAP, Dok, KSR, MyD88, Crk, CrkL, GAD, Nck, Grb2 associated binder (GAB), Fas associated death domain (FADD), TRADD, TRAF2, RIP, T-cell leukemia family, IL-2, IL-4, IL-8, IL-6, interferon y, interferon a, suppressors of cytokine signaling (SOCs), Cbl, SCF ubiquitination ligase complex, APCIC, adhesion molecules, integrins, Immunoglobulin-like adhesion molecules, selectins, cadherins, catenins, focal adhesion kinase, p130CAS, fodrin, actin, paxillin, myosin, myosin binding proteins, tubulin, eg5/KSP, CENPs, P-adrenergic receptors, muscarinic receptors, adenylyl cyclase receptors, small molecular weight GTPases, H-Ras, K-Ras, N-Ras, Ran, Rac, Rho, Cdc42, Arfs, RABs, RHEB, Vav, Tiam, Sos, Dbl, PRK, TSC1,2, Ras-GAP, Arf-GAPS, Rho-GAPS, caspases, Caspase 2, Caspase 3, Caspase 6, Caspase 7, Caspase 8, Caspase 9, Bcl-2, Mel-1, Bcl-XL, Bcl-w, Bcl-B, Al, Bax, Bak, Bok, Bik, Bad, Bid, Bim, Bmf, Hrk, Noxa, Puma, IAPB, XIAP, Smac, Cdk4, Cdk 6, Cdk 2, Cdk1, Cdk 7, Cyclin D, Cyclin E, Cyclin A, Cyclin B, Rb, p16, p14Arf, p27KIP, p21CIP, molecular chaperones, Hsp90s, Hsp70, Hsp27, metabolic enzymes, Acetyl-CoAa Carboxylase, ATP citrate lyase, nitric oxide synthase, caveolins, endosomal sorting complex required for transport (ESCRT) proteins, vesicular protein sorting (Vsps), hydroxylases, prolyl-hydroxylases PHD-1, 2 and 3, asparagine hydroxylase FIH transferases, Pin1 prolyl isomerase, topoisomerases, deacetylases, Histone deacetylases, sirtuins, histone acetylases, CBP1P300 family, MYST family, ATF2, DNA methyl transferases, Histone H3K4 demethylases, H3K27, JHDM2A, UTX, VHL, WT-1, p53, Holm, PTEN, ubiquitin proteases, urokinase-type plasminogen activator (uPA) and uPA receptor (uPAR) system, cathepsins, metalloproteinases, esterases, hydrolases, separase, potassium channels, sodium channels, multi-drug resistance proteins, P-Gycoprotein, nucleoside transporters, Ets, Elk, SMADs, Rel-A (p65-NFKB), CREB, NFAT, ATF-2, AFT, Myc, Fos, Spl, Egr-1, Tbet, p-catenin, HIFs, FOXOs, E2Fs, SRFs, TCFs, Egr-1, pcatenin, FOX0 STAT1, STAT 3, STAT 4, STAT 5, STAT 6, p53, WT-1, HMGA, pS6, 4EPB-1, eIF4E-binding protein, RNA polymerase, initiation factors, elongation factors, Bevacizumab, FG-22 16; Ezatiostat; Clofarabine; growth factor therapy, such as G-CSF, GM-CSF, IL-3, EPO, EPO plus G-CSF, Hematide, thrombopeitin; Immunosuppressive agents such as Cyclosporine, Anti-thymocyte globulin agents; Receptor tyrosine kinase inhibitors such as, AG3340, SC10-469; Gleevec, Sorafenib; survival signal inhibitors such as Farnesyl transferase inhibitors Tipifarnib and Lonafarnib; pharmacologic differentiators, such as TLK199; thrombopoiesis-stimulating agents such as IL-11; Lena1idomide; Arsenic trioxide, alone or in combination with azacitidine or with tipifarnib and gemtuzumab ozogamicin; hypomethylating drugs, such as Azacitidine and Decitabine; histone deacetylase inhibitors, such as Vorinostat and valproic acid; or agents for the reversal of epigenetic gene silencing, apoptosis inhibition, immune modulation, angiogenesis inhibition; cytarabine and an anthracycline drug, such as, daunorubicin or idarubicin, and 6-thioguanine.

A detection element (or stain) can be, for example, a molecule used for visualization and/or quantification of a molecule or a structure, especially in a cell. Examples of stains include antibodies, fluorochromes, and/or a combination thereof.

As shown in FIG. 1, the experiment file 12 can be defined based on interactions (e.g., instructions, inputs) of a user (not shown) with the experiment management engine 120 via the user interface 130, and based on inventory information related to one or more substances (e.g., test substance 10) included in the physical inventory 150. In some embodiments, the user can be, for example, a scientist, an administrator, a technician (e.g., a laboratory technician), and so forth. In some embodiments, the experiment file 12 can include one or more experimental parameter values (e.g., instructions) that are defined so that the test device 140 can process (e.g., to physically process, to process data related to) the test substance 10 based on experimental parameter values included in the experiment file 12. The experimental parameter values can define a testing procedure (e.g., a testing profile (also can be referred to as an experiment profile)).

For example, the test device 140 can stimulate at least a portion of the test substance 10 at a specified temperature(s) and/or time(s) (e.g., a duration of time), move at least a portion of the test substance 10 in a specified fashion, detect a specified characteristic(s) and/or response(s) related to the test substance 10, analyze data related to the test substance 10 in a specified fashion, dispose of one or more portions of the test substance 10 in a particular fashion, and so forth based on experimental parameter values included in the experiment file 12.

Although not shown, the test substance 10 can be associated with (e.g., disposed on, included in, contained in) a testing substrate (e.g., a multiwell plate). The testing substrate can be, for example, a slide (e.g., a glass slide) upon which the test substance 10 is disposed during processing at the test device 140. In some embodiments, the testing substrate can be, for example, a container such as a tube (e.g., a test tube) from which the test substance 10 is pumped to the test device 140 for processing. In some embodiments, the test substance 10 can be included in one or more of a plurality of test sites (e.g., wells) from an array or matrix of test sites that define at least a portion of a testing substrate. The location of the test substance 10 with respect to the testing substrate and/or with respect to other test substances can be defined based on one or more experimental parameter values that define an experimental layout. The experimental layout can define locations (e.g., a mapping) of one or more test substances (e.g., test substance 10) within a testing substrate. In some embodiments, a location of a test substance within a testing substrate can be referred to as a test site. In some embodiments, terms such as “layout,” “plate layout,” “experimental layout,” can refer to, but are not limited to, a layout of a plate being used in an experiment, whether it is for research or diagnosis.

In some embodiments, the experiment file 12 can include one or more experimental parameter values related to attributes of the test substance 10 (and/or another test substance (not shown)). For example, experimental parameter values representing the composition, origin, characteristics, reactivity, expiration date, quantity, and so forth of one or more portions of the test substance 10 (e.g., a sample, a reagent) can be included in the experiment file 12. In some embodiments, these experimental parameter values can be communicated to the test device 140 so that the test device 140 can process the test substance 10 accordingly. In some embodiments, the experimental parameter values representing the attributes of the test substance 10 can be communicated in the experiment file 12 with respect to an experimental layout. For example, an experimental parameter value representing composition information can be associated with a well where the test substance 10 is disposed.

In some embodiments, the experiment file 12 can include information that may not be used by the test device 140 to process the test substance 10 during a testing procedure. For example, the experiment file 12 can include information about a physical property or characteristic of the test substance 10 that may not be used by the test device 140 during a testing procedure.

In some embodiments, the experiment file 12 can include experimental parameter values that may be used after test substance 10 has been processed at the test device 140 based on a testing procedure. For example, the experiment file 12 can include experimental parameter values that can be used during an analysis phase (e.g., statistical analysis phase) of data obtained based on processing of the test substance at the test device 140 during a processing phase. In some embodiments, for example, the experiment file 12 can include an experimental parameter value representing a diagnosis related to a sample included in the test substance 10. Analysis related to the test substance 10 (after a processing phase) can be performed based on experimental parameter value representing the origin of the sample.

In some embodiments, one or more portions of the experiment file 12 can include experimental parameter values (e.g., processing instructions, data about the test substance 10) that can be accessed by a user of the test device 140 so that the user can trigger the test device 140 to process the test substance 10 in a desirable fashion. For example, the experiment file 12 can be configured so that a user can access composition information related to the test substance 10 and can process the test substance 10 at the test device 140 based on the composition information.

In some embodiments, one or more portions of the experiment file 12 can include notes input by a user. For example, the experiment file 12 can include one or more user notes about preparation of the test substance 10. In some embodiments, the user notes can be related to processing of the test substance 10 at the test device 140 based on a testing procedure. In some embodiments, user notes can be entered based on a selection from a list (e.g., a list in a drop-down menu) provided by the experiment management engine 120.

The experiment file 12 can be defined by the experiment management engine 120 so that the experiment file 12 can have a format that can be processed by the test device 140. For example, the experiment file 12 can have a format that can be interpreted by (e.g., compatible with) the test device 140 (or an application associated with the test device 140). In some embodiments, the experiment file 12 can include and/or can be defined based on a procedural instruction set, a text-based file, an image, and so forth.

In some embodiments, the experiment management engine 120 can be configured to define experiment files (such as experiment file 12) that are compatible with multiple test devices (such as test device 140 or other third party test devices/equipment) even though one or more of the multiple test devices may be configured to operate based on different (and possibly incompatible) platforms. Moreover, the experiment file 12 can be defined based on input requirements for a test device (e.g., a third party test device) such as test device 140. For example, the experiment management engine 120 can be configured to define a first experiment file that is compatible with a first test device platform a second experiment file that is compatible with a second test device platform. In some embodiments, the experiment management engine 120 (e.g., the experimental module 222 of the experiment management engine 120) can be configured to define the experiment file 12 so that the experiment file 12 is compatible with an application programming interface (API) associated with, for example, one or more test devices, applications (e.g., test device applications), and/or other equipment. In some embodiments, a translation (or mapping) module (not shown) can be configured to define and/or translate one or more portions of the experiment file 12 so that the portions of the experiment file 12 are compatible with processing capabilities of a particular test device. For example, in some embodiments, the experiment file 12 can be defined so that it is compatible with DIVA software by Becton Dickinson.

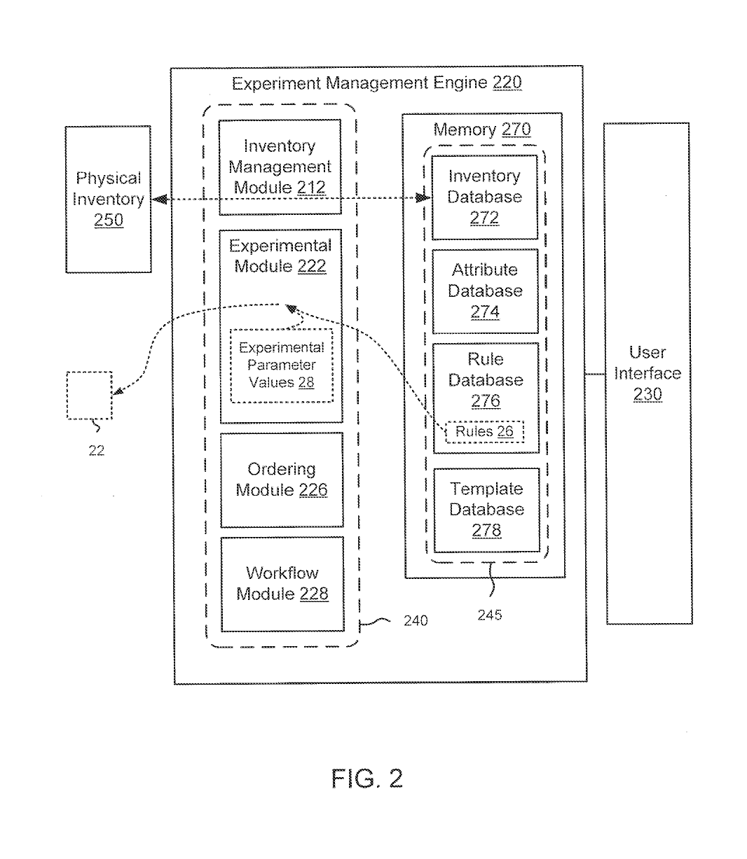

In some embodiments, the experiment file 12 can be sent to the test device 140 and stored at the test device 140 until the test substance 10 is ready for processing at the test device 140. In some embodiments, the experiment file 12 can be configured so that the experiment file 12 can be matched with the test substance 10. For example, the experiment file 12 can be configured so that the experiment file 12 can be invoked when a bar code associated with the test substance 10 is matched to the experiment file 12. More details related to defining of an experiment file are described in connection with, for example, FIG. 2.

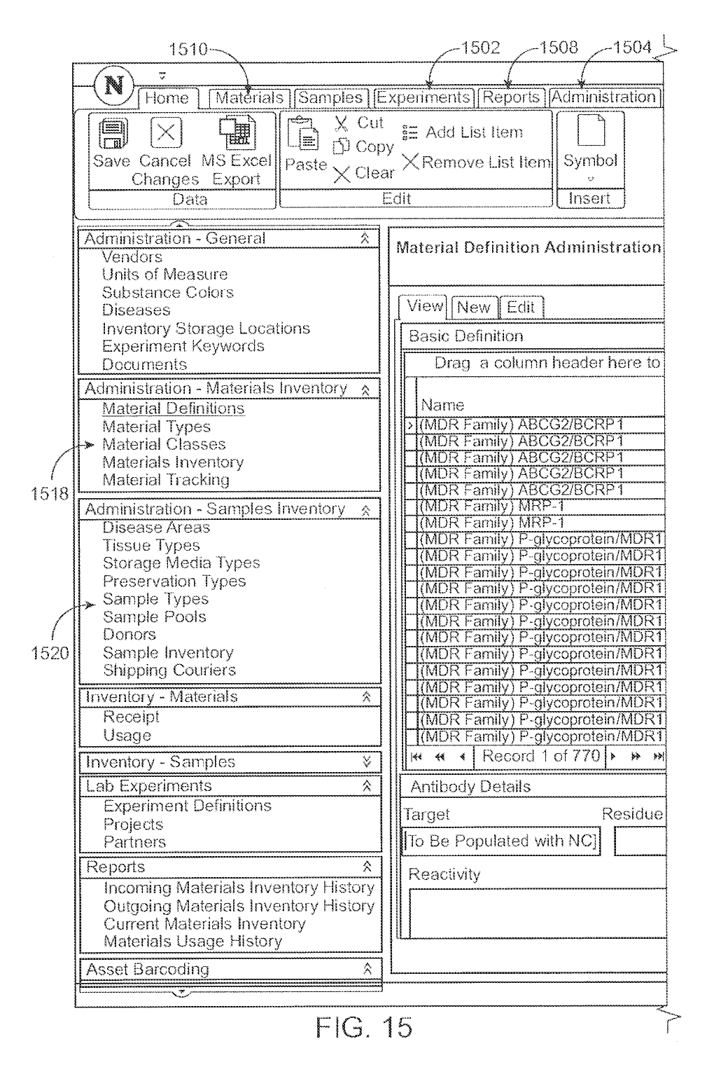

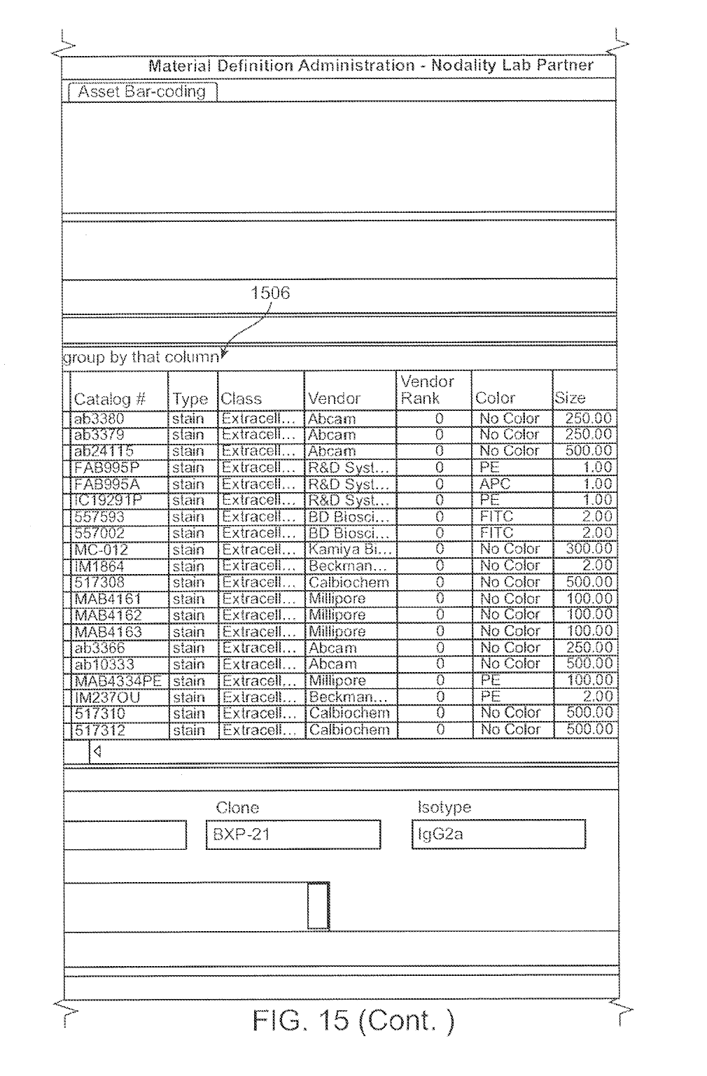

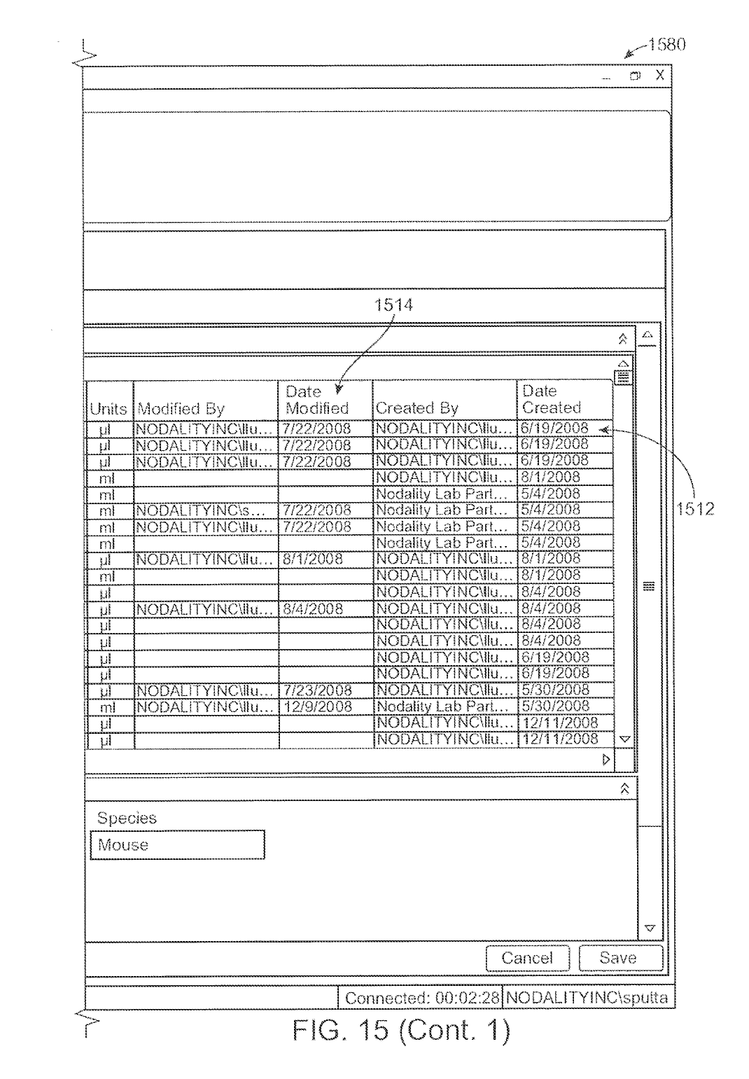

As shown in FIG. 1, the experiment management engine 120 can be accessed via a user interface 130 (e.g., a graphical user interface (GUI)). The user interface 130 can be configured so that a user can send signals (e.g., control signals, input signals, signals related to instructions) to the experiment management engine 130 and/or receive signals (e.g., output signals) from the experiment management engine 130. Specifically, the user interface 130 can be configured so that the user can trigger one or more functions to be performed (e.g., executed) at the experiment management engine 120 via the user interface 130 and/or receive an output signal from the experiment management engine 120 at, for example, a display (not shown) of the user interface 130. For example, in some embodiments, a user can manage (e.g., update, modify) at least a portion of a database via the user interface 130. In some embodiments, the user interface 130 can be a user interface associated with, for example, a personal computer and/or a server. For example, a variety of different combinations and implementations of GUIs may be used. In some embodiments, an inventory management GUI, a layout design GUI, and/or an experimental design GUI can be displayed on the user interface 130. More details related user interfaces are described in connection with FIGS. 15 through 19. In addition, more details related to the user interface are set forth in co-pending patent application Ser. No. 61/079,551, filed on Jul. 10, 2008, entitled “Systems and Methods for Experimental Design, Layout and Inventory Management,” and co-pending patent application Ser. No. 61/087,555, filed on Aug. 8, 2008, entitled “System and Method for Providing a Bioinformatics Database,” both of which have been incorporated herein by reference in their entireties.

In some embodiments, one or more portions of the user interface 130, the physical inventory 150, the experiment management engine 120, and/or the test device 140 can be a hardware-based module (e.g., a digital signal processor (DSP), a field programmable gate array (FPGA), a memory), a firmware module, and/or a software-based module (e.g., a module of computer code, a set of computer-readable instructions that can be executed at a computer). In some embodiments, one or more of the functions associated with the user interface 130, the physical inventory 150, the experiment management engine 120, and/or the test device 140 can be included in one or more different modules (not shown). In some embodiments, one or more portions of the user interface 130, the physical inventory 150, the experiment management engine 120, and/or the test device 140 can be a wired device and/or a wireless device (e.g., wi-fi enabled device) and can be, for example, a computing entity (e.g., a personal computing device), a mobile phone, a personal digital assistant (PDA), a server (e.g., a web server/host), and/or so forth. The user interface 130, the physical inventory 150, the experiment management engine 120, and/or the test device 140 can be configured to operate based on one or more platforms (e.g., one or more similar or different platforms) that can include one or more types of hardware, software, firmware, operating systems, runtime libraries, and so forth.

In some embodiments, the user interface 130 (or portion of the user interface 130), the physical inventory 150 (or portion of the physical inventory 150), the test device 140 (or portion of the test device 140) and/or the experiment management engine 120 (or portion of the experiment management engine 120) can be configured to communicate via a network (not shown). In some embodiments, the network can be, for example, a virtual network, a local area network (LAN) and/or a wide area network (WAN) and can include one or more wired and/or wireless segments. For example, the experiment management engine 120 can be accessed (e.g., manipulated) as a web-based service. Accordingly, the user interface 130 can be, for example, a personal computer, and the experiment management engine 120 can be accessed via, for example, the Internet. In some embodiments, the experiment management engine 120 can be configured to facilitate communication (e.g., collaboration) between users (e.g., users at separate, remote locations).

As represented by line 16 shown in FIG. 1, output data can be sent to (e.g. uploaded to, transmitted to) the experiment management engine 120 from the test device 140. The output data can include test data produced at the test device 140 based on testing of the test substance 10 using the experiment file 12. In some embodiments, the output data can also include at least a portion of the experiment file 12. In some embodiments, the output data can be automatically uploaded from the test device 140 to the experiment management engine 120 and/or the output data can be retrieved by the experiment management engine 120 based on, for example, a schedule and/or in response to a request by a user. In some embodiments, the output data can be stored in a memory (not shown) that can be accessed by the experiment management engine 120. At least a portion of the memory can be local to the experiment management engine 120 and/or at least a portion of the memory can be remote to the experiment management engine 120.

In some embodiments, output data received at the experiment management engine 120 can be related to multiple experiments that can be performed at one or more test devices (such as test device 140). Accordingly, analysis of output data performed at the experiment management engine 120 (or at a different device to which the experiment management engine 120 exports the output data) can be related to multiple experiments and/or multiple test devices.

In some embodiments, the experiment management engine 120 can be configured to define and/or process (e.g., analyze) one or more gates (also can be referred to as gate boundaries) within output data received at the experiment management engine 120. The gates can be defined at and/or processed at, for example, a gating module (not shown). In some embodiments, for example, a metric related to a robustness of a gate can be calculated based on random perturbations of the gate within output data. This analysis can be performed at a gating module of the experiment management engine 120.

In some embodiments, the experiment management engine 120 can be configured to export the output data (or a portion thereof) to a device (or module) where one or more gates can be defined. The information related to the gate(s) (e.g., gate definitions) as well as the output data (in a raw form or an analyzed form) can be imported into the experiment management engine 120 where the information related to the gate(s) and/or the output data (in a raw form or an analyzed form) can be processed. The gate(s) imported into the experiment management engine 120 can be processed (e.g., analyzed) at the experiment management engine 120.

In some embodiments, one or more portions of output data (e.g., a portion of the output data associated with a well or other sample) and/or one or more gates associated with output data can be invalidated at the experiment management engine 120. For example, the portion(s) of the output data and/or the gate(s) can be invalidated based on one or more conditions that can be applied by the experiment management engine 120. In such instances, the portion(s) of the output data and/or the gate(s) can be deleted and/or associated with an indicator of the invalidation. In some embodiments, the portion(s) of the output data and/or the gate(s) can be invalided manually by a user via the experiment management engine 120.

In some embodiments, the test device 140 can be configured to send output data to the experiment management engine 120 so that one or more portions of the experiment file 12 can be associated with the output data at the experiment management engine 120. For example, the test device 140 can be configured to produce test data at the test device 140 based on the experiment file 12. The experiment management engine 120 can be configured to store a local copy of the experiment file 12 at the experiment management engine 120. The test device 140 can include one or more identifiers in test data that is sent to the experiment management engine 120 so that the experiment management engine 120 can associate the local copy of the experiment file 12 with the test data from the test device 140. In such instances, one or more portions of the experiment file 12 may not be transmitted back to the experiment management engine 120.

In some embodiments, output data from the test device 140 can be processed (e.g., processing during an analysis phase) at the experiment management engine 120. For example, in some embodiments, output data can be analyzed and/or filtered based on one or more parameter values produced at the test device 140 based on testing performed at the test device 140. In some embodiments, output data can be analyzed and/or filtered based on one or more parameter values included in the experiment file 12 associated with (e.g., included in) the output data from the test device 140. In some embodiments, output data from the test device 140 can be processed based on one or more gate boundaries (e.g., a template gate boundary). For example, portions of output data from the test device 140 can be separated (e.g., filtered) based on a gate boundary. More details related to processing of data, such as output data, based on gate boundaries are described in co-pending U.S. patent application bearing attorney docket no. NODA-002/01US 309855-2006, filed on Jul. 10, 2009, entitled, “Methods and Apparatus Related to Gate Boundaries within a Data Space,” and co-pending U.S. Patent Application No. 61/079,579, filed on Jul. 10, 2008, entitled “Gating Sensitivity Data Analysis,” both of which are incorporated herein by reference in their entireties.

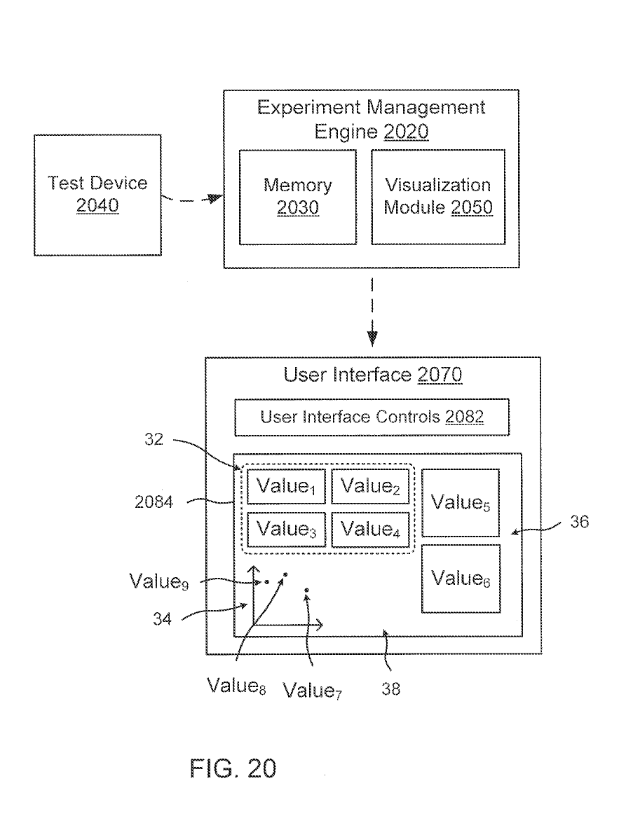

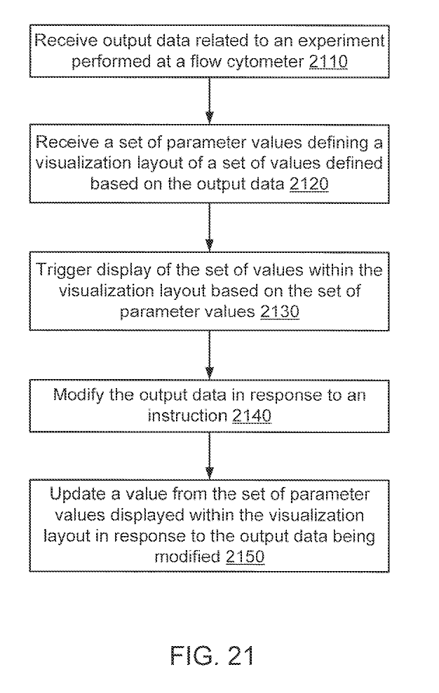

In some embodiments, output data from the test device 140 can be processed at the experiment management engine 120 so that one or more values based on (e.g., calculated based on) the output data can be viewed by a user within a portion of the user interface 130 (e.g., a display of the user interface 130). In some embodiments, the experiment management engine 120 can be configured to trigger display of the one or more values within a visualization layout within the portion of the user interface 130 so that the value(s) (and/or a representation thereof) can be viewed by a user. For example, output data can be accessed and/or manipulated (e.g., mathematically manipulated) to define a set of values. At least a portion of set of values can then be displayed at the user interface 130 within a visualization layout (e.g., a user-defined/customized visualization layout, a template visualization layout). More details related to processing of output data at an experiment management engine for display within a visualization layout of a user interface are described in connection with FIG. 20 and FIG. 21, and are described in co-pending U.S. Patent Application No. 61/079,537, filed on Jul. 10, 2008, entitled, “Method and System for Data Extraction and Visualization of Multi-Parametric Data,” which is incorporated herein by reference in its entirety.

FIG. 2 is a schematic block diagram that illustrates components within an experiment management engine 220, according to an embodiment. As shown in FIG. 2, the experiment management engine 220 includes several modules 240 as well as databases 245 stored in a memory 270. Specifically, the experiment management engine 220 includes an inventory management module 212 configured to process signals related to inventory items (e.g., test substances, plates, test tubes) stored at a physical inventory 250, an experimental module 222 configured to define an experiment file 22, a notification module 224 configured to send notifications related to processing at the experiment management engine 220, an order module 226 configured to order inventory items related to the physical inventory 250, and a workflow module 228. An inventory database 272, an attribute database 274, a rule database 276, and a template database 278 are stored in the memory 270.

In some embodiments, one or more of the databases (or portions of the databases) included in the memory 270 can be, for example, a relational database, a distributed database, a set of linked tables, and/or so forth. Although shown as being included in the experiment management engine 220, in some embodiments, one or more of the databases (or portions of the databases) can be remote databases (e.g., non-local databases) that can be accessed by the experiment management engine 220.

The functions performed by the modules 240 and/or databases 245 are integrated at the experiment management engine 220. For example, the modules 240 are configured so that data defined by at least one of the modules 240 and stored in one of the databases 245 can be accessed and used by another of the modules 240. In some embodiments, one or more of the modules 240 can be configured to define and send one or more signals directly to another of the modules 240. The functionality of the modules 240 and/or database 245 is described in more detail below. In some embodiments, the information stored in databases 245 can be stored in, for example, a single database or different databases (e.g., distributed databases, remotely accessed databases) than those shown in FIG. 2. In some embodiments, the databases 245 can be, for example, relational databases implemented using, for example, MS Access, FoxPro, Interbase, Microsoft SQL, Mysql, Oracle, Sybase, Btrieve, FileMaker, PostgreSQL, and so forth.

As shown in FIG. 2, the experiment management engine 220 can be accessed via a user interface 230. In some embodiments, the user interface 230 can be a user interface associated with, for example, a wired device and/or a wireless device (e.g., wi-fi enabled device) and can be, for example, a computing entity (e.g., a personal computing device), a mobile phone, a personal digital assistant (PDA), a server (e.g., a web server/host), and/or so forth. Execution of one or more of the functions associated with the modules 240 and/or the databases 245 can be triggered via the user interface 230. For example, one or more entries representing inventory items included in the inventory database 272 can be modified (e.g., deleted, added) via the user interface 230.

In some embodiments, access to the modules 240 and/or databases 245 can be defined based on an identifier associated with a user. For example, a user may have authorization to access to (e.g., be authorized to trigger functions related to) only a portion of the experiment management engine 220 (e.g., only a subset of the modules 240 at the experiment management engine 220 and/or only a subset of information stored in the databases 245 at the experiment management engine 220) via the user interface 230. The authorized access of the user may be determined and/or administered based on, for example, login information (e.g., a username and/or password associated with the user).

The inventory database 272 can be configured to store inventory information related to inventory items such as test substances, equipment (e.g., test tubes, testing substrates), and so forth stored in the physical inventory 250. For example, the inventory database 272 can be configured to store inventory information such as a quantity, a quality, a composition, a class, a color, and/or an origin (e.g., a supplier) of a test substance (e.g., a tissue sample) stored in the physical inventory 250. In some embodiments, the inventory information can include one or more attributes of one or more test substances. In some embodiments, the inventory information can include inventory information related to equipment such as a brand, size, price, and/or quantity of the equipment. In some embodiments, a graphical representation (e.g., a list, a table) of the inventory items included in the inventory database 272 can be accessed (e.g., viewed on a display) by a user via the user interface 230. In some embodiments, one or more portions of the inventory database 272 can be made available to users based on whether or not the user is authorized to access the portion(s).

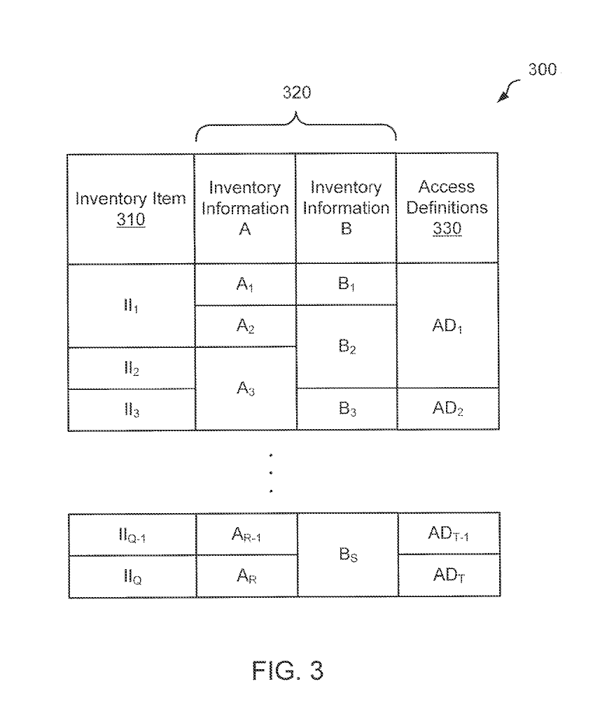

FIG. 3 is a schematic diagram that illustrates an inventory database 300, according to an embodiment. As shown in FIG. 3, the inventory database 300 includes inventory items II₁ through II_{Q} (shown in column 310), inventory information A and B (shown at 320), and access definitions (shown in column 330). The inventory items 310 can be, for example, entries representing test substances (e.g., samples, reagents), test substrates, tools needed to prepare a test substance for testing, and so forth. For example, inventory item II₂ can represent a particular blood sample that is stored in a physical inventory.

The inventory information 320 can represent parameter values such as, for example, an availability (e.g., unavailable, available, reserved), a composition, a quantity, an origin, an instruction (e.g., a storage instruction, a handling instruction), an expiration date, a restriction, a characteristic, a location (e.g., a physical location) related to one or more of the inventory items 310. In some embodiments, the inventory information 320 can include any attribute related to the inventory items 310. For example, inventory information A₁ can be an indicator that inventory item II₁ has a particular purity level or is stored in a particular cabinet. Inventory information B₁ can be an indicator that inventory item II₁ has a particular weight or is unavailable.

The access definitions 330 represent whether or not a particular group of users or individual user may be permitted to access to the inventory items 310 and/or the inventory information 320. For example, the access definition AD₁ can represent that a specified group of users (e.g., all users) or a specified user can have access to inventory items II₁ and inventory II₂ as well as inventory information 320 related to these inventory items. In some embodiments, the access definitions 330 can be defined so that one or more users can be authorized to access (e.g., read, write, use) only certain portions of the inventory database 300. For example, a user can be authorized to view inventory information A₃ (which may represent an availability) related to inventory item II₂, but may not be authorized to view inventory information B₂ (which may represent an origin) related to inventory item II₂. In some embodiments, an authorization level of a user can be determined by an inventory management module (such as that shown in FIG. 2) based on the access definitions 330 included in the inventory database 300.

Referring back to FIG. 2, the inventory management module 212 can be configured to process signals related to inventory stored at a physical inventory 250. Specifically, the inventory management module 212 can be configured to update (e.g., automatically update) inventory information stored in the inventory database 272 when a change is made to the physical inventory 250. For example, if an inventory item is removed (or will be removed) from the physical inventory 250 for use in a test (e.g., an experiment) to be executed at a test device (not shown), the inventory management module 212 can be configured to update the inventory database 272 accordingly. In some embodiments, an indicator that an inventory item is unavailable if the inventory item has been reserved for use in an experiment. If an inventory item is added (or will be added) to the physical inventory 250 after being returned without being used (or after being ordered), the inventory management module 212 can be configured to update the inventory database 272 accordingly.

In some embodiments, handling (e.g., removal, use, modification) of inventory items (e.g., test substances, equipment) stored in the physical inventory 250 can be tracked (e.g., logged) using identifiers (e.g., an identifier unique within a specified domain) associated with (e.g., affixed to, embedded within) the inventory items. The identifiers can be used to track inventory items during any phase of an experiment (e.g., a preparation phase, a processing phase, an analysis phase). For example, a date/time stamp of handling of an inventory item, intended use of an inventory item, a location of an inventory item (e.g., a location in a specified refrigerator or cabinet), and other information that can be entered by a user can be logged. In some embodiments, identifiers associated with inventory items can be used to associate the inventory items with a particular lot and/or batch of inventory items. In some embodiments, identifiers associated with inventory items can be used to validate a characteristic and/or an authenticity of an inventory item.

Identifiers associated with inventory items can be defined based on, for example, a bar code system, a color-coding system, and/or a radio frequency identification (RFID) tag system. For example, a bar code identifier (e.g., a sample or a testing substrate) can be automatically defined (e.g., created, printed) and can be affixed to an inventory item when the inventory item is added to the physical inventory 250 so that later handling (e.g., removal, use) of the inventory item can be tracked (e.g. logged) by the experiment management engine 120. In some embodiments, an identifier such as a bar code affixed to an inventory item such as a bottle of a reagent can be scanned when the inventory item is removed from the physical inventory 250 so that removal of the inventory item can be logged. If the inventor item has been, for example, removed for use in during a preparation phase of an experiment, the design management engine 250 can be configured to prevent other users from selecting the removed inventory item for use in another experiment.

In some embodiments, an inventory item can be included in the inventory database 272 and can be made available for selection for an experiment even though the inventory item is not yet in the possession or physical inventory of the testing laboratory, or does not even yet physically exist. For example, a particular inventory item that may be produced as part of a portion of an experiment can be made available as an inventory item for selection for a later portion of the experiment (even though the inventory item has not yet been physically produced). In some embodiments, for example, a particular inventory item that has been ordered and may arrive in time for use during a portion of an experiment can be made available (e.g., made available for selection) as an inventory item when defining the experiment even though the inventory item is not currently physically available in, for example, the physical inventory 250. In some embodiments, the experiment management engine 220 can be configured to determine when this type of inventorying should be allowed (such as in the situations described above) or when a conflict (e.g., an unrealistically tight shipping timeline) related to this type of inventorying is detected. In some embodiments, the experiment management engine 220 can be configured to allow a user to override a conflict so that an experiment (or experimental planning) may proceed.

In some embodiments, inventory items (e.g., samples and/or reagent) used in different experiments can be linked by the experiment management engine 220. In other words, historical usage of inventory items or specific types of inventory items can also be linked by the experiment management engine 220. Accordingly, data produced based on the different experiments can be linked and/or analyzed together based on the linkage between the inventory items.

In some embodiments, the inventory management module 212 can be configured so that a user can make changes to one or more entries included in the inventory database 272 via the user interface 230. For example, the inventory management module 212 can be configured to modify an entry (e.g., remove a test substance, change a quantity of a test substance) included in the inventory database 272 in response to an instruction received from a user via the user interface 230. In some embodiments, a user can manually modify information (e.g., incorrect information) included in the inventory database 272 via the user interface 230, if authorized to do so by the inventory management module 212 and/or inventory database 272.

As shown in FIG. 2, the experimental module 222 can be configured to define the experiment file 22 based on one or more experimental parameter values 28. In some embodiments, the experimental module 222 can be configured to modify one or more experimental parameter values 28 and/or can be configured to define additional experimental parameter values that can be included in the experiment file 22.

The experimental parameter values 28 can include any attributes related to a test substance and/or equipment. For example, locations (x, y coordinates within a plate), quantities (e.g., volumetric quantities), and/or compositions (e.g., mass percentage) of test substances such as biological samples and/or reagents. In some embodiments, the experimental parameter values 28 can include information related to the limitations or capabilities of a test device and/or testing substrate.

The experimental parameter values 28 can also define any portion of a testing procedure. For example, the experiment parameter values 28 can include an order for testing test substances, a sensor (e.g., a temperature sensor, a pressure sensor, a heating device, a detector, a laser) to be used during testing of a test substance, data to be logged during testing of a test substance, a timing for detection of responses during testing of a test substance, disposal of test substances after testing, sending of logged data related to testing of a test substance, parameter values representing an experimental layout, information related to analysis of data, and so forth.

In some embodiments, attributes (e.g., validation information, manufacturer information, titration data) stored in an attribute database 274 can be associated with, for example, a test substance and/or equipment related to a test substance. The attribute database 274 can include, for example, general attributes from documentation related to test substances (e.g., common test substances) and/or testing substrates. For example, if a particular attribute related to a test substance is not already associated with a test substance, the experimental module 222 can be configured to query the attribute database 274, retrieve the attribute from the attribute database 174, and associate the attribute with the test substance (if the attribute is available in the attribute database 274). In some embodiments, the attribute database 272 can be linked to other databases so that information related to, for example, inventory items included in the physical inventory 250 (and/or inventory items that could be included in the physical inventory 250) can be retrieved from the other databases and included in (e.g., used to update) the attribute database 272. For example, the experiment management engine 220 can be configured to retrieve information that is stored in an antibody database and/or a fluorescent dye database. The information can subsequently be included in (e.g., stored in, used to update) the attribute database 272. In some embodiments, the information (e.g., information related to inventory items such as reagents, antibodies, and/or fluorophores) in the attribute database 272 can be automatically refreshed and/or updated based on information from various companies randomly and/or on a regularly basis (e.g., continually). In some embodiments, one or more portions of the attribute database 274 can be defined based on a know-how and/or empirical data that can be input by a user via the user interface 230.

One or more of the experimental parameter values 28 (e.g., an experimental parameter value associated with an experimental layout) can be defined by a user based on inventory items included in the inventory database 272 via the user interface 230. For example, a user can access a list of inventory items included in the inventory database 272 (such as that shown in FIG. 3) via the user interface 230. An experimental parameter value representing a selection of a testing substance from the list of inventor items can be included in the experimental parameter values 28. Another experimental parameter value representing a desired placement of the testing substance within a testing substrate can be included in the experimental parameter values 28. Yet another experimental parameter value representing a desired type of processing (e.g., test procedure) to be performed on the testing substance can be included in the experimental parameter values 28. In some embodiments, a user can exclude, for example, one or more attributes related to a test substance and/or equipment from being represented by the experimental parameter values 28.

In some embodiments, an experimental layout can be defined using a design and layout generator module (not shown) associated with the experimental module 222. For example, the design and layout generator module can be used by a user via one or more graphical user interfaces (displayed at the user interface 230) so that the user can design a layout of a plate being used in an experiment and/or view and enter portions of test substances for each well in the layout of the plate so that wells and the portions of the test substances are associated in a desirable fashion. The layout of the plate can be used in conducting the experiment (e.g., a flow cytometry experiment).

In some embodiments, at least some of the experimental parameter values 28 can be defined based on an experiment template retrieved from the template database 278. The experiment template can include one or more predefined experimental parameter values. For example, an experiment template can include a predefined type of processing (e.g., test procedure) to be performed on a predefined test substance at a predefined location within a testing substrate. In some embodiments, the experiment template can also include instructions related to predefined procedure for preparation of for example, a test substance for processing at the test device. In some embodiments, an experiment template can be referred to as a cocktail. In some embodiments, one or more experiment templates can be stored in the template database 278 where more than one or more users can access and use the experiment template(s). In some embodiments, one or more of the experiment templates can be accessed only by users (e.g., groups of user, individual users) authorized to access the experiment templates. For example, the experiment management engine 220 can be configured to manage access to experimental parameter values (e.g., reagent amounts, processing conditions) associated with specific wells associated with a testing substrate.

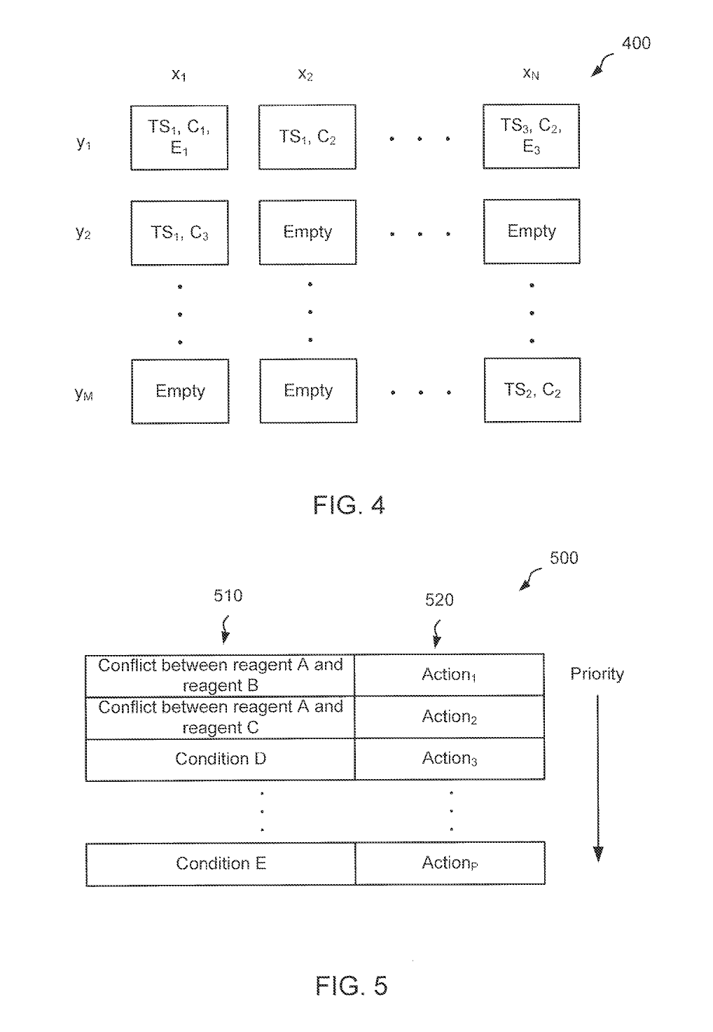

FIG. 4 is a schematic diagram that illustrates an experiment template 400, according to an embodiment. As shown in FIG. 4, the experiment template 400 includes a matrix of test sites that define an experimental layout. The locations of the test sites are represented by a combination of one of the x-coordinates x₁ through x_{N} (on the x-axis) and one of the y-coordinates y₁ through y_{M} (shown on the y-axis).

As shown in FIG. 4, test site x₁, y₁ includes, for example, predefined experimental parameter values for a test substance TS₁ with a composition C₁ (e.g., a composition of a sample and a reagent) and a test procedure E₁. Test site x₁, y₂ includes, for example, predefined experimental parameter values for a test substance TS₁ with a composition C₃, but does not include a predefined experimental parameter value for a test procedure. Test site x_{N}, y₂ does not include any predefined experimental parameter values as represented by the “Empty” notation.

An experiment template such as that shown in FIG. 4 can be stored in a template database (not shown in FIG. 4) and can be selected by a user for a particular experiment to be performed at a test device. In some embodiments, a user can be authorized to add to the experimental parameter values included in the experiment template 400 and/or change one or more of the experimental parameter values included in the experiment template 400. In some embodiments, a user can save a modified version of the experiment template 400 as a different experiment template (not shown) in a template database. The different experiment template can be referred to as a customized experiment template.

In some embodiments, experiment templates can include more predefined experimental parameter values than those shown in FIG. 4. For example, in some embodiments, an experiment template can include experiment parameter values (e.g., instructions) related to a workflow, experimental parameter values related to a preparation procedure for a test substance, and so forth.

Referring back to FIG. 2, the experimental module 222 can be configured to define the experiment file 22 based on one or more rules 26 retrieved from a library of rules stored at the rule database 276. In some embodiments, one or more of the rules 26 can be retrieved from the rule database 276 based on one or more of the experimental parameter values 28. For example, a rule related to testing of a particular test substance can be retrieved from the rule database 276 based on an experimental parameter value(s) representing the test substance. Each of the rules 26 can be defined so that an action (e.g., sending of a notification, a modification of an experimental parameter value) can be performed in response to a condition being satisfied (or unsatisfied).

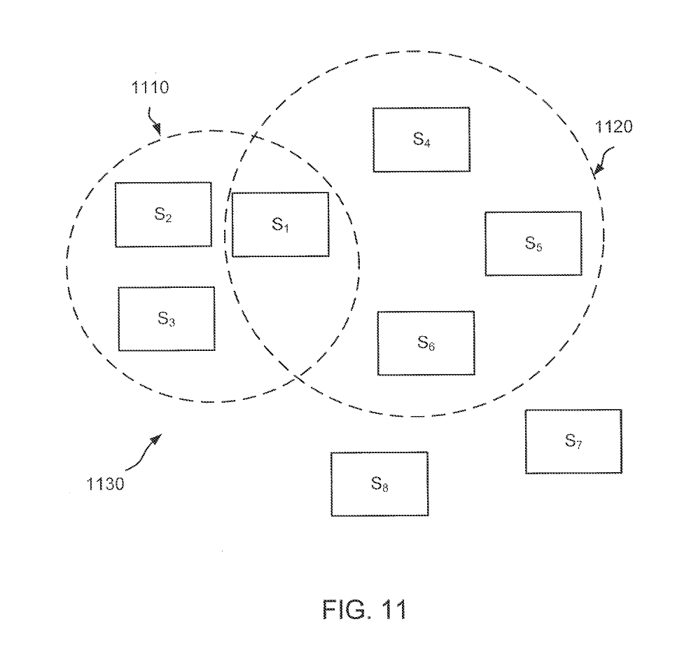

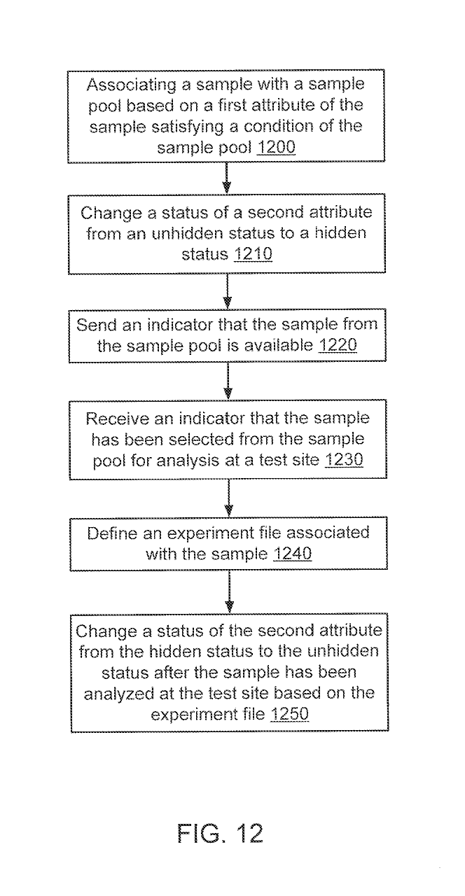

For example, an action can be performed when a conflict (e.g., a potential conflict) between one or more experimental parameter values 28 is detected based on one or more of the rules 26. In some embodiments, a user can be notified (via the user interface 230) when a cross-reactivity issue or incompatibility between two or more of the experimental parameter values 28 is detected. For example, an incompatibility of a stain with a sample (both within a test substance) can be identified based on a condition (e.g., a threshold condition) within one of the rules 26 being satisfied. In response to this incompatibility, a user can be prevented from using the stain and/or the sample. In some embodiments, a user can be notified if, for example, a volume of a sample to be pipetted is below an acceptable and/or desirable range. In some embodiments, the user can be required to receive approval before being allowed to use the stain and/or the sample, and/or can be required to override (e.g. manually override) the use prohibition in order to use the stain and/or the sample. In some embodiments, the incompatibility of portions of test substances at different test sites can be determined based one or more conditions included in on one or more rules 26. In some embodiments, the passing of an expiration date associated with a test substance and/or an insufficient supply of a particular test substance can be identified based on one or more conditions included in one or more of the rules 26. In some embodiments, one or more of the rules 26 can be configured to trigger a fall-off calculation. More details related to fall-off calculations are described in connection with FIGS. 11 and 12.

In some embodiments, one or more of the rules 26 can be defined based on an attribute (e.g., a limitation) of equipment (e.g., a testing substrate, a test device). In some embodiments, for example, one of the rules 26 can be used to identify and notify a user that a particular reagent may attenuate or amplify a response from a sample in an undesirable fashion at a particular test device.

In some embodiments, the experiment management engine 220 can be configured to perform an action (e.g., send a notification to a user) based on information representing a capability of a test device. The information representing the capability of the test device can be referred to as capability information. The experiment management engine 220 can be configured to store capability information that indicates, for example, that a test device is capable of emitting laser energy (to excite a specified set of fluorophores) from a specified number of laser sources and/or is capable of detecting specified ranges of wavelengths at a specified number of detectors. In some embodiments, the capability information can be uploaded to the experiment management engine 220 via the user interface 230.

In some embodiments, the experiment management engine 220 can be configured to define (based on one or more rules 26) a configuration (or configurations) of a test device that can be used for a specified set of conditions related to an experiment based on capability information related to the test device. In some embodiments, the experiment management engine 220 can be configured to suggest (based on one or more rules 26) test substances that could be used in an experiment at the test device based on the capability information. In some embodiments, the experiment management engine 220 can be configured to notify a user (via the user interface 230) when an issue related to incompatibility of one or more portions of an experiment with a configuration of the test device and/or a capability of the test device is detected. For example, the experiment management engine 220 can be configured to detect and/or notify a user (based on a rule 26), for example, when one or more signals (e.g., emissions) to be measured at the test device may be too close together such that they will overlap and/or cause other issues (e.g., compensation issues). In sum, the experiment management engine 220 can be configured to flag potential problems that would not be otherwise obvious to a user.

In some embodiments, one or more of the rules 26 can be defined based on data stored at the memory 270 by one or more users of the experiment management engine 220 (or a test device). For example, a user can define a new rule (e.g., conditions associated with the new rule) based on information (e.g., know-how, knowledge) acquired during an experiment. In some embodiments, threshold limits, conditions, filters, etc. associated with the new rule can be defined by the user via the user interface 230. The new rule can then be applied to experimental parameter values associated with subsequent experiments. In some embodiments, one or more of the rules 26 can be defined based on, for example, information related to commonly used sets of reagents with a given test device configuration. In other words, one or more of the rules 26 in the rules database 276 can be defined based on a know-how and/or empirical data. In some embodiments, the rule database 276 (and/or any of the other databases included in the experiment management engine 220) can function as a knowledge database and can have rules defined based on information (e.g., empirical data/information) included in the knowledge database.

In some embodiments, one or more of the experimental parameter values 28 can be automatically defined based one or more of the rules 26. For example, a quantity or a composition of a test substance can be defined (e.g., modified) based on one of the rules 26. In some embodiments, one or more of the experimental parameter values 28 can be converted from one set of units (e.g., system international (SI) units, English units) to another set of units based on a rule 26. In some embodiments, the experimental module 222 can be configured to recalculate a quantity of a test substance when the quantity of the test substance falls below a threshold condition included in one of the rules 26. The threshold condition can be defined (or triggered) based on a quantity of the test substance needed to produce a desirable result at a test device.

In some embodiments, one or more of the rules 26 can be a user-specific rule. For example, one or more of the rules 26 can be defined by a specific user and/or retrieved for use in defining an experiment file 22 for a specific user. Moreover, the rules 26 can be selected based on an identifier (e.g., a username) associated with a user. The identifier can be determined in response to a login process.

In some embodiments, the rules 26 can be defined so that one of the rules 26 take priority over another of the rules 26. In some embodiments, conflicts between the rules 26 can be handled based on a priority value associated with the rules 26. For example, if a first rule from rules 26 would define one of the experimental parameter values 28 in a different way than a second rule from the rules 26, the first rule can be applied instead of the second rule if the first rule has a higher priority value than a priority value associated with the second rule. In some embodiments, the priority values associated with the rules 26 can be dynamically defined based on an identity of a user. For example, the experimental module 222 can be configured to define the experimental parameter values 28 based on a first set of priority values associated with the rules 26 when the experiment management engine 220 is being used by a user from a first user group and based on a second set of priority values associated with the rules 26 when the experiment management engine 220 is being used by a user from a second user group. In some embodiments, an experiment template can be defined so that a specified set of rules are used when experimental parameter values are defined based on the experiment template.

In some embodiments, the rules 26 can be defined so that the experiment management engine 220 can send a suggestion related to an experiment when a condition within one of the rules 26 is satisfied. For example, a suggestion of an appropriate reagent-sample combination for an experiment can be sent to a user when a potentially inappropriate reagent-sample combination is detected for the experiment. In some embodiments, the experiment management engine 220 can be configured, for example, to suggest based on the rules 26 test device configurations when a detector of the test device has a limitation with respect to a sample-reagent combination, an experimental layout, a primary and/or a secondary reagent (e.g., antibodies) to resolve a conflict between reagents, and so forth.

For example, the experiment management engine 220 can be configured to present a list of test substances (e.g., proteins) available (e.g., currently available, available in the future) in the physical inventory 250. A user can select, via the user interface 230, one or more of the test substances (e.g., proteins, antibodies) that are of interest in a particular experiment. The experiment management engine 220 can be configured to suggest, for example, color combinations and/or staining setups that are compatible with the selected test substances. In some embodiments, the experiment management engine 220 can be configured to make suggestions based on a set of reagents commonly used by the user or others (as defined within a knowledge database). In some embodiments, the suggestions can be defined based on user preferences related to, for example, test configurations, rankings of targets, preferred test channels that have a specified sensitivity, and/or so forth.

FIG. 5 is a schematic block diagram that illustrates rules 500 that can be used to define experimental parameter values, according to an embodiment. As shown in FIG. 5, each of the rules 500 includes a condition 510, and an action 520 to be performed when the conditions 510 is satisfied. For example, action₃ can be performed when condition D is satisfied. The action₃ can include, for example, sending a notification, suggesting a resolution to a conflict, recalculating an experimental parameter value associated with an experiment, and so forth.

As shown in FIG. 5, the rules 500 are ordered in descending priority. In other words, the rule with the highest priority value is at the top of the list and the rule with the lowest priority value is at the bottom of the list. Thus, in this embodiment, if a conflict between reagents A and B, and a conflict between reagents A and C are identified, action₁ rather than action is performed based on the priority values.

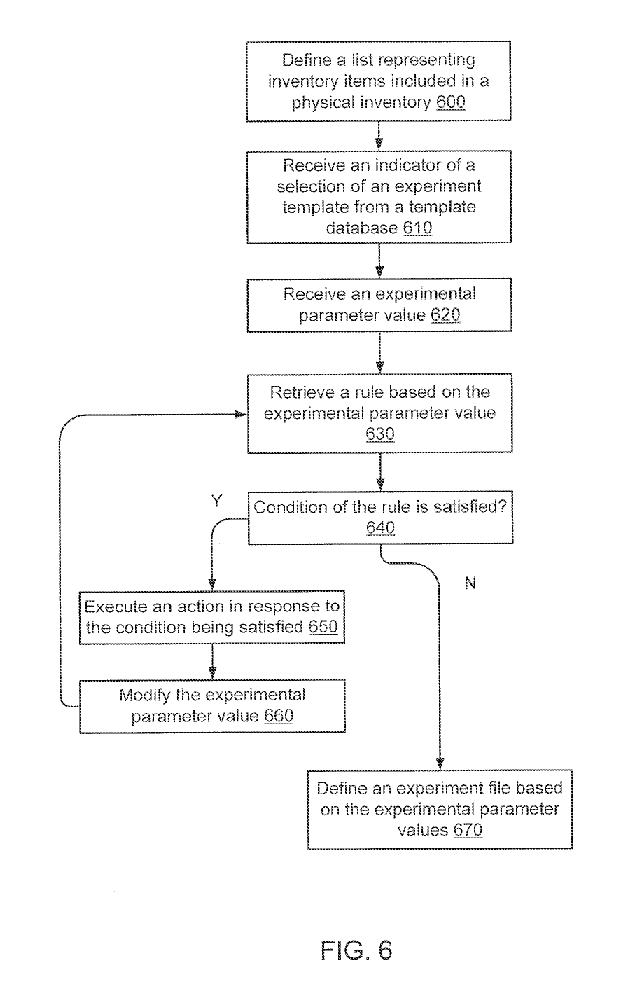

FIG. 6 is a flowchart that illustrates a method for defining an experiment file at an experiment management engine, according to an embodiment. A list representing inventory items included in a physical inventory is defined at 600. In some embodiments, the list of inventory items can be defined based on an identity of a user. For example, a subset of available inventory items can be defined based on the identity of the user. After the list of inventory items has been defined, the list can be displayed to a user via the user interface.

An indicator that an experiment template has been selected from a template database is received at 610. The indicator can be produced in response to a user selecting an experiment template from the template database via a user interface. In some embodiments, the list of inventory items can be defined based on the experiment template selected by the user. Accordingly, the experiment template can be selected by the user before a list of inventory items is defined.

An experimental parameter value is received at 620. In some embodiments, the experimental parameter value can be defined by a user via a user interface based on the experiment template and based on the list of inventory items. For example, a user can select an inventory item from the list of inventory items and can request that the inventory item be associated with a test site included in the experiment template.

A rule is retrieved based on the experimental parameter value at 630. The rule can be retrieved from a rule database based on the experimental parameter value. For example, if the experimental parameter value represents a quantity of a reagent, a rule related to the reagent can be retrieved from the rule database.

When a condition associated with the rule is satisfied at 640, an action associated with the condition can be executed at 650. The action can include, for example, sending of a suggestion related to the condition when the condition is satisfied. As shown in FIG. 6, after the action has been performed, the experimental parameter value can be modified, at 670. In some embodiments, a user can modify the experimental parameter value in response to a suggestion (sent at 660). In some embodiments, a different experimental parameter value can be modified to, for example, resolve a conflict defined within a condition. In some embodiments, the action can include modification of the experimental parameter value.

As shown in FIG. 6, blocks 630 through 660 can be performed iteratively until a condition of a rule is no longer satisfied. For example, during a second iteration, when the experimental parameter value 670 is modified, a new rule can be retrieved at 630 based on the modified parameter value and a condition associated with the new rule can be applied at 640. If the condition associated with the new rule is satisfied, an action associated with the condition can be executed at 650, and the modified experimental parameter value (or a different experimental parameter value) can be further modified at 660.

When a condition associated with the rule is not satisfied at 640, an experiment file is defined based on the experimental parameter value at 680. In some embodiments, the experiment file can be sent to a test device. In some embodiments, the experiment file can be defined so that the experiment file has a format that is compatible with the test device.

Referring back to FIG. 2, in some embodiments, the experimental module 222 can be configured to send an indicator to the inventory management module 212 when an inventory item is selected for use (or no longer selected for use) in an experiment. For example, if a specified reagent is selected for use in an experiment by a user via the user interface 230, the experimental module 222 can be configured to send an indicator of the selection to the inventory management module 212. The inventory management module 212 can update the inventory database 272 accordingly.

In some embodiments, the experimental module 222 can be configured to send an indicator to the inventory management module 212 when an inventory item is selected for use (or no longer selected for use) in an experiment based on a calculation performed by the experimental module 222. The calculation can be performed based on, for example, one of the rules 26.

In some embodiments, the ordering module 226 can be configured to automatically define an order for an inventory item (e.g., a test substance) to be stored in the physical inventory 250 when an ordering condition related to the inventory item is satisfied. For example, an inventory item can be automatically ordered by the ordering module 226 when a quantity of the inventory item falls below a quantity threshold value. In some embodiments, the ordering module 226 can be configured to track the order as it is being processed. For example, the ordering module 226 can be configured to log events such as ordering dates/times, receipt dates/times, storage dates/times. The ordering module 226 can be configured to notify a user (via the user interface 230) when an order has been place and can notify a user of handling instructions and/or physical storage requirements related to an order of an inventory item.

The workflow module 228 shown in FIG. 2 can be configured to manage a workflow related to any phase of an experiment (e.g., a preparation phase, a processing phase, an analysis phase). The workflow can include, for example, steps to be performed during preparation of a test substance for processing at a test device, checklists (or steps) related to design of an experiment or testing procedure, steps requiring approval, steps related to standard operating procedures (SOPs) for execution of an experiment, steps related to QA, auditing, and/or QC, steps related to correction of an error, steps related to data entry, and/or so forth. In some embodiments, a workflow can define one or more states of one or more experiments.

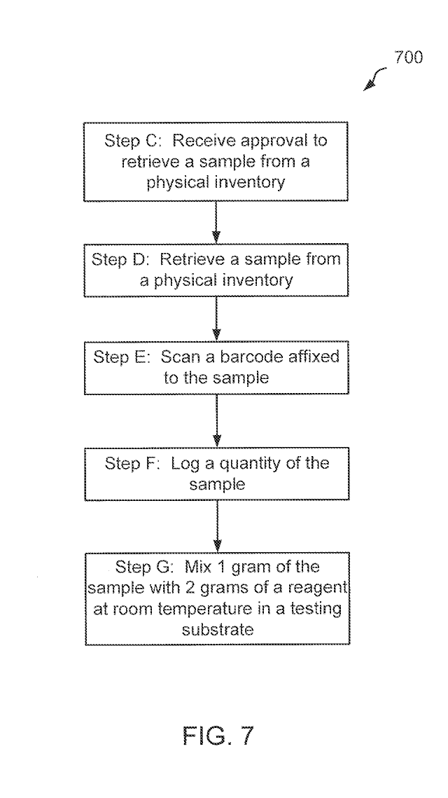

FIG. 7 is a diagram that illustrates an example of a portion of a workflow 700, according to an embodiment. The portion of the workflow shown in FIG. 7 is related to preparation of a test substance for processing at a test device. The workflow 700 is defined so that the test substance can be, for example, accurately and consistently prepared when a user prepares the test substance in accordance with the workflow 700. In some embodiments, the workflow 700 can be defined so that a user will not be allowed to proceed with subsequent steps in the workflow 700 until verification that a preceding step has been performed.

As shown in FIG. 7, the portion of the workflow 700 starts with receiving approval (e.g., authorization) to retrieve a sample from a physical inventory at Step C. In some embodiments, the workflow 700 can be defined so that a user will not be allowed to proceed with the workflow 700 (e.g., will not be allowed to view the remaining portions of the workflow) until approval has been received. In some embodiments, authentication (based on a username and password) of the authorization related to Step C can be required.

As shown in FIG. 7, the workflow 700 includes steps related to retrieving a sample from a physical inventory (Step D), scanning a barcode affixed to the sample (Step E), logging a quantity of the sample (Step F), and mixing 1 gram of the sample with 2 grams of a reagent at room temperature in a testing substrate (Step G). In some embodiments, the workflow 700 can include verification steps (based on input from a user), notes related to handling of inventory items, tips for obtaining desirable results, and so forth. In some embodiments, the workflow 700 can include an indicator representing a safe or unsafe stopping point within the workflow 700.

In some embodiments, workflow such as workflow 700 can be triggered in response to a condition related to a rule (e.g., one or more of the rules 26) being satisfied. For example, if a particular conflict during a preparation phase of an experiment is detected based on a rule, a workflow for resolving the conflict can be retrieved and executed. A workflow can include more or less steps than those shown in the example workflow 700. In addition, the steps in a workflow can vary from those shown in the example workflow 700.

In some embodiments, a workflow can be defined so that steps associated with the workflow (such as workflow 700) are performed with a desirable level of efficiency. For example, the workflow can be defined so that certain steps in a particular location will be performed as a group. Specifically, steps related to retrieving several inventory items from a single location (e.g., a single refrigerator) can be included in a workflow so that they are performed in succession or together.

In some embodiments, a workflow can be associated with an experiment template. Accordingly, the workflow can be executed when, for example, a preparation phase associated with an experiment template is defined. If the experiment template is used to define a different experiment template (e.g., a customized experiment template), the workflow can be modified accordingly. In some embodiments, a workflow such as workflow 700 can be stored in a workflow database (not shown) in one or more libraries of workflows from which the workflow can be retrieved by the workflow module 228.

Referring back to FIG. 2, the workflow module 228 can also be configured to track interactions with the experiment management engine 220 for auditing purposes. The tracking can include, for example, logging a date/time stamp that a particular interaction occurred and logging an identifier associated with a user at the time that particular interaction occurred. The tracking can include tracking related to handling of inventory items (e.g., removal of inventory items from the physical inventory 250). In some embodiments, for example, the execution of steps related to a workflow (such as workflow 700 shown in FIG. 7) can be tracked for auditing purposes.

In some embodiments, the workflow module 228 can be configured to trigger one or more notifications (e.g., indicators, e-mail notifications, alarms) in response to compliant and/or non-compliant behavior being detected. For example, if a step (or steps) in a workflow is skipped or not properly completed, a user (e.g., a supervisor) can be alerted to the deviation from the workflow. In some embodiments, the workflow module 228 can be configured to prevent a user from accessing a restricted workflow and/or from accessing a workflow that has been started (but not yet completed) by a different user.

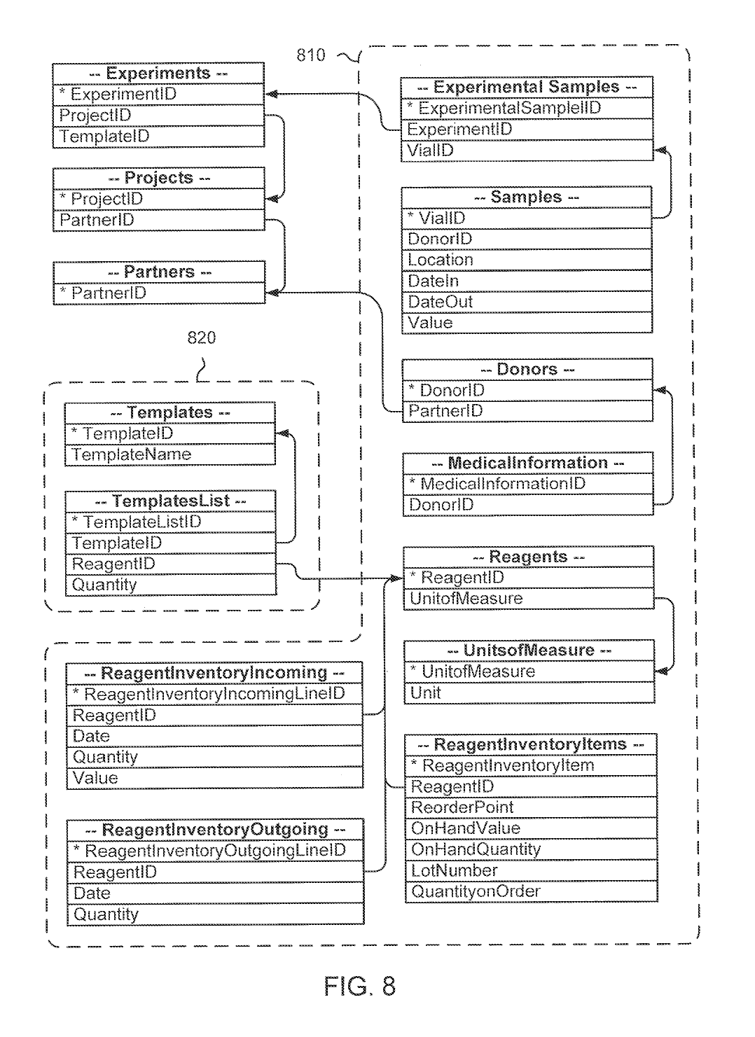

FIG. 8 is a schematic diagram that illustrates experimental parameter value relationships that can be managed at an experiment management engine, according to an embodiment. As shown in FIG. 8, categories of experimental parameter values can be stored in separate tables (also can be referred to as databases). For example, experimental parameter values associated with samples can be stored in a sample table (shown with the header “—Samples—”). In this embodiment, experimental parameter values included in the tables can be accessed via table keys. A “*” before an experimental parameter identifier within a table indicates that the identifier is a table key. The tables inside of the dashed line 810 can be stored in, for example, an inventory database (such inventory database 272 shown in FIG. 2) and/or an attribute database (such attribute database 274 shown in FIG. 2). The tables inside of the dashed line 820 can be stored in, for example, an template database such as template database 278 shown in FIG. 2.

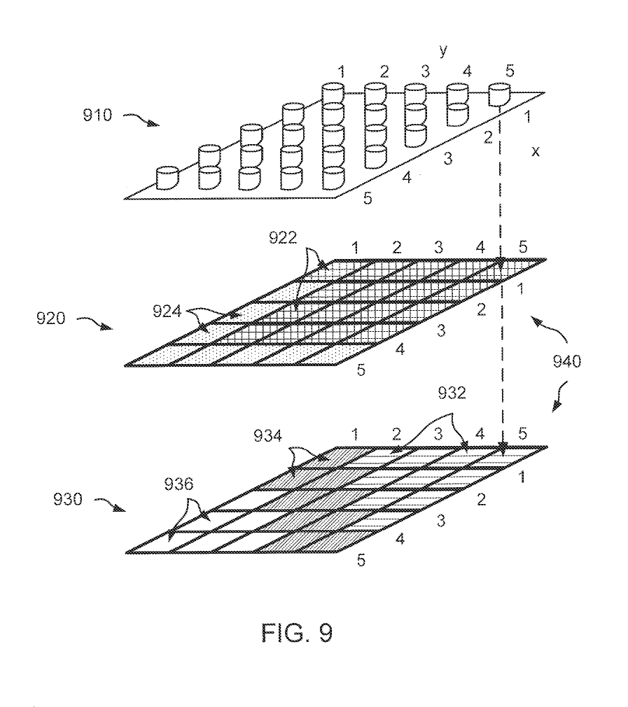

FIG. 9 is a schematic diagram that illustrates indicator layers associated with a test substrate, according to an embodiment. The test substrate, in this embodiment, includes a 5×5 matrix of wells (each of the wells can be referred to as a test site) and can be referred to as a plate 910. Each of the indicators included in indicator layer 920 spatially correspond with a test site of the plate 910, and represent a sample (e.g., a tissue type, a quantity, a composition) to be included in the plate 910. In this embodiment, the indicator layer 920 includes two different types of indicators that are associated with different samples: indicators 922 (cross-hatched) and indicators 924 (dotted). Similarly, each of the indicators included in indicator layer 930 spatially correspond with a test site of the plate 910 and represent a reagent (e.g., a modulator, a stain) to be included in the plate 910. In other words, the indicator layer 930 can represent at least a portion of an experimental layout. In this embodiment, the indicator layer 930 includes three different types of indicators that are associated with different reagents: indicators 932 (horizontal lines), indicators 934 (slanted lines), and indicators 934 (blank). In other words, the indicator layer 920 and/or the indicator layer 930 can represent at least a portion of an experimental layout. The indicator layer 920 and the indicator layer 930 can collectively be referred to as indicator layers 940.

The indicators included in the indicator layers 940 (or portions of the indicator layers 940) can be used (by a user or system (e.g., a manual system and/or an automated system)) to, for example, prepare test substances in each of the wells within the plate 910. For example, the indicator 922 at coordinates (x=1, y=5) of the indicator layer 920 can be used to determine (based on the indicator type) that a specified sample is to be included in the test site of the plate 910 at coordinates (1,5). In some embodiments, for example, the indicator 922 can be used to determine that a specified type and quantity of bone marrow tissue is to be included in the test site at coordinate (1,5). Similarly, the indicator 932 at coordinates (1,5) of the indicator layer 930 can be used to determine (based on the indicator type) that a specified reagent is to be included in the test site of the plate 910 at coordinates (1,5). In some embodiments, for example, the indicator 932 can be used to determine that a specified quantity and type of modulator is to be included in the test site at coordinates (1,5).

In some embodiments, one or more of the indicator layers 940 can be used by a user as a visual guide. For example, one or more of the indicator layers 940 can be placed below the plate 910 (which can be transparent or translucent) and can be used as a visual or optical guide by a user or system (e.g., automated system and/or a manual system) during preparation (e.g., during dispensing, during mixing) of test substances. Specifically, because the different indicators of the indicator layer 920, for example, have different patterns, the indicators can be used by a user to visually determine (in an accurate and/or quick fashion) which substances should be included in which test sites of the plate 910. In some embodiments, if an automated system is being used, then the indicator layers 940 can be read by, for example, a camera or other device.

In some embodiments, the indicators included in the indicator layers 940 (or a different indicator layer) can be and/or can include any combination of colors, patterns, and/or shapes. For example, a solid color can be used an indicator. In some embodiments, the indicator layers 940 can have a different form than those shown in FIG. 9. For example, one or more of the indicator layers 940 can be defined so that they fit on top of the plate 910 and can have holes defined so that a sample and/or a reagent can be placed through the holes into the test sites of the plate 910. In some embodiments, one or more of the indicator layers 940 can be projected onto the plate 910 from a projection device (e.g., a light emitting projection device). In some embodiments, the indicators layers 940 can be made out of, for example, a metal, a plastic, a bio-compatible material, and/or a paper.

In some embodiments, an indicator layer can include an indicator that a material (e.g., a sample) should not be included in a test site or that a material should be removed from a test site. In some embodiments, an indicator layer can include a notification such as, for example, a warning (e.g., a warning symbol, a warning label, a warning note) related to a potential cross-contamination issue.

In some embodiments, one or more of the indicator layers 940 can be defined, viewed (e.g., viewed via a GUI), and/or produced (e.g., printed on paper), for example, during a workflow. In some embodiments, the one or more of the indicator layers 940 (or portions of the indicator layers 940) can be defined manually by a user via, for example, an experiment management engine during a preparation phase (e.g., an experimental design portion of the preparation phase) of an experiment. In some embodiments, the experiment management engine can be configured to present a user with options (via a user interface) that can be selected and used to define one or more of the indicator layers 940. In some embodiments, one or more of the indicator layers 940 can be defined based on a preference associated with a user. For example, a preference associated with a user can be defined so that a particular indicator is automatically defined within an indicator layer. The indicator layer can later be used by the user during physical preparation of a test substance.

In some embodiments, the indicator layers 940 (or portions of indicator layer 940) can be defined so that they are used in a particular order. For example, indicator layer 920 (or a portion of indicator layer 920) can be used to determine which samples should be included in the test sites of the plate 910 before indicator layer 930 (or a portion of indicator layer 930) is used to determine which reagents should be included in the test sites of the plate 910. In some embodiments, the order of the indicator layers 940 can be different. In some embodiments, a workflow can be defined so that an indicator layer (or portion of the indicator layer) is and/or can only be used in a particular order with respect to other indicator layers (or portions of indicator layers). For example, in some embodiments, a workflow can be defined so that an indicator layer (or portion of an indicator layer) can only be produced and/or viewed after preparation of a portion of a test substance associated with another indicator layer (or portion of an indicator layer) have been completed.

In some embodiments, an indicator layer such as indicator layers 940 can be defined so that the indicator layer can be used in an automated fashion. For example, an indicator layer(s) can be defined so that a machine such as a robot can use the indicator layer(s) to prepare one or more test substances. In other words, the indicator layer(s) can be defined so that the machine can detect a characteristic of the indicator as a guide in preparing the test substance.

In some embodiments, the indicator layers can be used during testing of a test substance. For example, in some embodiments, information related to indicator layer 930 and/or a physical copy of the indicator layer 930 can be used by a test device and/or a user of the test device when processing a test substance (prepared based on the indicator layer 930) at the test device.

In some embodiments, indicators included on a single indicator layer can include multiple different indicators related to one or more test sites. For example, in some embodiments, an indicator layer can include an indicator representing a sample to be included in a test site and a separate indicator representing a quantity to be included in the same test site.

Although FIG. 9 is related to a plate 910, in some embodiments, indicator layers can be defined for different types of testing substrates. In some embodiments, more or less indicator layers than those shown in FIG. 9 can be associated with a test substrate. For example, an additional indicator layer (not shown) representing a second set of reagents to be included in at least some of the test sites of the plate 910 can be associated with the plate 910. In some embodiments, one or more indicator layers can be included in an experiment template such as those described in connection with FIGS. 2, 4, and 6.

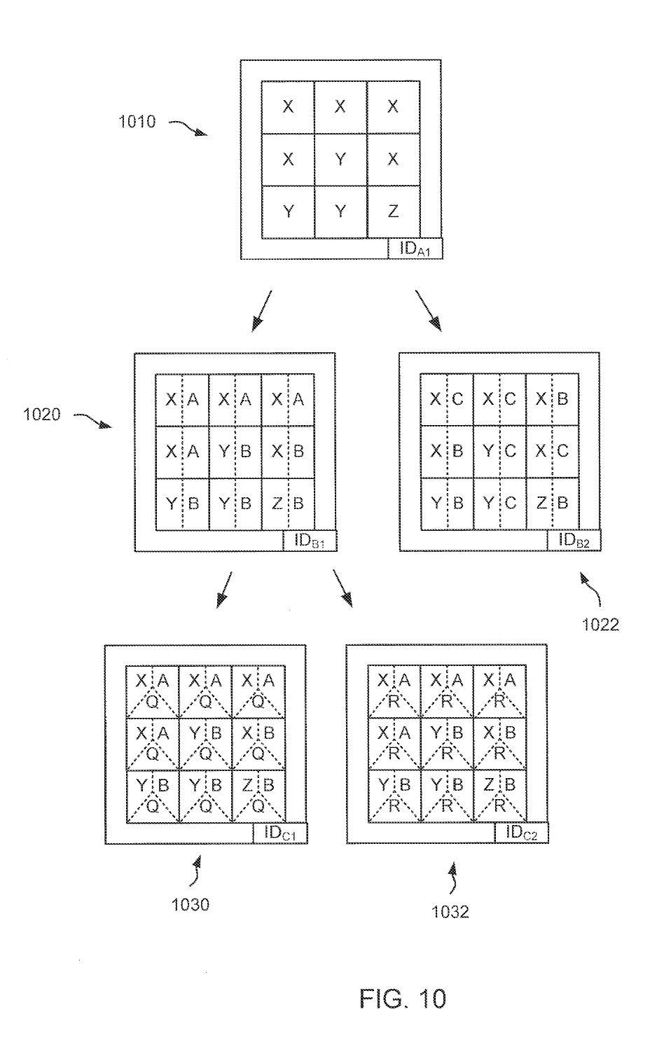

FIG. 10 is a schematic diagram that illustrates hierarchically related testing substrates and test substances, according to an embodiment. In this embodiment, the combination of the test substance and the testing substrate can be referred to as a prepared plate (or as a prepared test substrate). As shown in FIG. 10, the testing substances included in prepared plate 1020 and prepared plate 1022 are defined based the testing substances included in prepared plate 1010. Accordingly, the prepared plate 1020 and the prepared plate 1022 can be referred to as children (e.g., child prepared plates) or daughters (e.g., daughter prepared plates) of the prepared plate 1010, which can be referred to as a parent (e.g., parent prepared plate) or a mother (e.g., mother prepared plate).

Specifically, the prepared plate 1010 includes samples X and Y arranged in a 3×3 matrix. The prepared plates 1020 and 1022 include the same pattern of samples X and Y arranged in 3×3 matrices as the prepared plate 1010, however, the prepared plate 1020 includes a different pattern of reagents (e.g., modulators, stains) than the prepared plate 1022. The prepared plate 1020 includes a pattern of reagents A and B, and the prepared plate 1022 includes a pattern of reagents B and C. In some embodiments, the different prepared plates 1020 and 1022 can be related to experiments for exploration of different pathways related to a biological reaction.

Similarly, the testing substances included in prepared plate 1030 and prepared plate 1032 are defined based the testing substances included in prepared plate 1020. Accordingly, the prepared plate 1030 and the prepared plate 1032 can be referred to as, for example, children or daughters of the prepared plate 1020. The prepared plates 1030 and 1032 include the same pattern of samples and reagents arranged in 3×3 matrices as the prepared plate 1020, but the prepared plate 1020 includes a different pattern of reagents (e.g., modulators, stains) than the pattern of reagents included in prepared plate 1022. Specifically, each of the test sites in prepared plate 1020 include reagent Q, and each of the test sites in prepared plate 1022 include reagent R. In some embodiments, the prepared plate 1030 and the prepared plate 1032 can be referred to as, for example, grandchildren (e.g., grandchild prepared plates) or granddaughters (granddaughter prepared plates) of the prepared plate 1010, which can be referred to as a grandparent (e.g., a grandparent prepared plate). In some embodiments, the production of one or more child plates can be triggered based on a workflow such as that described in connection with FIG. 7.

In some embodiments, the prepared plates 1020 and 1022 can be prepared directly from the prepared plate 1010. For example, a portion (e.g., half) of the test substances included in the prepared plate 1010 can be dispensed onto a test substrate to produce prepared plate 1020, and another portion (e.g., a remaining half) of the test substances included in the prepared plate 1010 can be dispensed onto a test substrate to produce prepared plate 1022. By preparing child plates in this fashion, the child plates will be substantially identical. Moreover, the child plates will have been produced under substantially the same conditions (e.g., temperature, pressure, timing) and using substantially the same test substances (e.g., test substances in substantially the same biological state, from the same manufacturing lots).

In some embodiments, after the prepared plates 1020 and 1022 have been produced based on the prepared plate 1010, the test substances included in the prepared plates 1020 and 1022 can be fixed (e.g., fixed using a fixative, fixed based on a biological reaction) so that the prepared plates 1020 and 1022 can be, for example, stored in a physical inventory. Similarly, after the prepared plates 1030 and 1032 have been produced based on the prepared plate 1020, the test substances included in the prepared plates 1030 and 1032 can be fixed so that the prepared plates 1030 and 1032 can be, for example, stored in a physical inventory. In some embodiments, the fixing process can be triggered based on a workflow.

As shown in FIG. 10, in this embodiment, each of the prepared plates is separately labeled with a different identifier so that they can be individually tracked in a physical inventory. Specifically, after each of the prepared plates has been produced, each of the prepared plates can be inventoried (e.g., included in an inventory database) as a separate inventory item. As shown in FIG. 10, the prepared plate 1010 is labeled with identifier ID_{A1}, the prepared plate 1020 is labeled with identifier ID_{B1}, the prepared plate 1022 is labeled with identifier ID_{B2}, the prepared plate 1030 is labeled with identifier ID_{C1}, and the prepared plate 1032 is labeled with identifier ID_{C2}. Information related to the prepared plates can be stored in an inventory database and can be linked based on their respective identifiers so that information related to parentage can be accessed (e.g., processed, retrieved, analyzed). For example, information related to the creation of a parent prepared plate (e.g., a creation date of the parent plate, origin of samples used to prepare the parent plate) can be associated with one or more children prepared plates, and vice versa. By preparing hierarchically prepared plates and separately inventorying them, complex experiments spanning a relatively long time period (e.g., several minutes, several days, several weeks, several months) can be conducted with a desirable level of continuity, consistency, and/or accuracy. In addition, data produced during the experiments can be desirably linked (e.g., hierarchically linked, linked via parentage) via, for example, the identifiers.

In addition, in some embodiments, each of the prepared plates, after being included in an inventory database as an inventory item, can be used (e.g., selected) as an inventory item similar to the way in which a sample and/or a reagent can be used as an inventory item. For example, after prepared plate 1020 has been inventoried during a preparation phase of a first experiment, it can be used in a second experiment. A stain unrelated to the first experiment can be added to the prepared plate 1020 to produce a prepared plate for processing in the second experiment. In some embodiments, the first experiment and the second experiment can be substantially unrelated. For example, the planning of the first experiment can be conducted independently of the planning related to the second experiment by different users.

In some embodiments, one or more of the prepared plates shown in FIG. 10 can be prepared based on one or more indicator layers such as those described in connection with FIG. 9. For example, the prepared plate 1010 can be prepared based on a first indicator layer, and the prepared plate 1020 and the prepared plate 1022 can be prepared, respectively, based on a second indicator layer and a third indicator layer.

In some embodiments, one or more child prepared plates can be prepared based on one or more indicator layers without being physically produced from common prepared plates. For example, a child prepared plate can be prepared based on a first indicator layer and a second indicator layer using a set of samples and reagents. The first indicator layer represent an experimental layout of samples and the second indicator layer can represent an experimental layout of reagents. A different child plate can be prepared based on the first indicator layer and a third indicator layer using a different set of samples of reagents. The third indicator layer can represent an experimental layout of reagents. Both of the child plates can be related (e.g., hierarchically related) in, for example, in information stored in an inventory database based on the common indicator layer. In some embodiments, the child plates can be referred to and/or identified as being related (e.g., having common parentage), even though the child plates are not physically prepared from a common sample and/or a common parent prepared plate.

FIG. 11 is a schematic block diagram that illustrates samples included in sample pools, according to an embodiment. As shown in FIG. 11, sample S₁ through sample S₃ are included in sample pool 1110 (illustrated by a dashed circle), and sample S₃ through sample S₆ are included in sample pool 1120 (illustrated by a dashed circle). Sample S₇ and sample S₈ are not included in either sample pool 1110 or sample pool 1120 as illustrated by their respective position outside of the dashed circles. The sample S₃ is included in both sample pool 1110 and sample pool 1120. The samples S₁ through S₆ (the samples included in at least one of the sample pools) can collectively be referred to as samples 1130. Each of the samples 1130 are included in one of the sample pools based on an attribute associated with each of the samples 1130 satisfying a condition associated with the sample pool. In some embodiments, each of the samples 1130 can include, for example, multiple vials of biological matter from a donor. In some embodiments, one or more of the samples 1130 can be from one or more donors.

For example, sample S₁ through sample S₃ can be included in sample pool 1110 because these samples have a common attribute (e.g., a common origin, a common blood type, a common tissue characteristic) that satisfies a condition for being included in sample pool 1110. Similarly sample S₃ through sample S₆ can be included in sample pool 1120 because these samples have a common attribute that satisfies a condition for being included in sample pool 1120. Sample S₇ and sample S₈ are not included in either of sample pool 1110 or sample pool 1120 because these samples do not have any attributes (known attributes) that satisfy the conditions for being included in these sample pools.

The sample pools can be defined to facilitate anonymization of samples for a single research experiment or set of research experiments. In some embodiments, a sample pool, such as sample pool 1110, can be defined for use in a set of research experiments. In some embodiments, the research experiments can be defined based on a scientific question.

When a sample (e.g., sample S₁) is included in a sample pool (e.g., sample pool 1110), one or more attributes associated with the sample can be hidden (also can be referred to as being locked) so that a user may not be biased to select the sample for an experiment based on the attributes associated with the sample (except for the attribute(s) used to define the sample pool). In other words, by defining sample pools that include samples with hidden attributes, a user can randomly select a sample from a sample pool with substantially only an awareness of the sample having a common subset of attributes that define the sample pool.

After the sample has been processed (e.g., tested) at a test device, attributes that were previously hidden can have their status changed from a hidden status (e.g., a hidden state) to an unhidden status (e.g., an unhidden state). The changing of a status of attributes from an unhidden status to a hidden status when defining a sample pool can be referred to as blinding, and the changing of the status of attributes from the hidden state to the unhidden state can be referred to as unblinding. In some embodiments, sample pools can be defined within an inventory database such as that shown in FIG. 3.

In some embodiments, hidden attributes and/or unhidden attributes associated with a sample can be included in an experiment file defined by an experiment management engine. Thus, the attributes associated with the sample can be used, if necessary, by a test device to which the experiment file is transmitted. Specifically, one or more of the hidden attributes and/or unhidden attributes can be used during, for example, testing of the sample at the test device. In addition, after processing of the sample at the test device the hidden attributes and/or unhidden attributes can be used to analyze data produced by the test device during testing of the sample.

In some embodiments, the sample pools shown in FIG. 11 can be related to a one or more phases of an experiment. For example, one or more of the samples from the sample pools can be related to a portion of a clinical study (e.g., a trial phase of a clinical study, a test phase of a clinical study). In some embodiments, metadata identifying the phase of an experiment of one or more samples from the sample pool can be associated with the sample(s).

FIG. 12 is a flowchart that illustrates a method for processing a sample associated with a sample pool, according to an embodiment. A sample is associated with a sample pool based on a first attribute of the sample satisfying a condition of the sample pool at 1200. The first attribute can be related to, for example, an origin of the sample, a chemical characteristic of the attribute, a diagnosis of a patient from whom the sample was taken, and so forth. In some embodiments, the sample can be included in more than one sample pool.

A status of a second attribute is changed from an unhidden status to a hidden status at 1210. In some embodiments, the second attribute can be changed from the unhidden status to the hidden status before the sample is associated with the sample pool. In some embodiments, the first attribute as well as the second attribute can be changed from an unhidden status to a hidden status. In some embodiments, a user can be authorized to access the second attribute at an inventory database even though the second attribute has a hidden status.

An indicator that the sample from the sample pool is available is sent at 1220. The indicator can be, for example, an indicator in a list of inventory items available in a physical inventory. In some embodiments, the indicator can be sent to a user via a user interface.

An indicator that the sample has been selected from the sample pool for analysis at a test site is received at 1230. In some embodiments, the sample can be selected from a sample pool by a user via a user interface.

An experiment file associated with the sample is defined at 1240. The experiment file can be defined based on one or more experiment parameter values associated with the sample. In some embodiments, the experiment file can be defined based on the first attribute and/or the second attribute associated with the sample.

A status of the second attribute is changed from the hidden status to the unhidden status after the sample has been processed at the test site based on the experiment file at 1250. In some embodiments, the sample can be processed at, for example, a test device. The second attribute can be changed from the hidden status to the unhidden status so that the data produced based on the processing can be analyzed based on the second attribute.

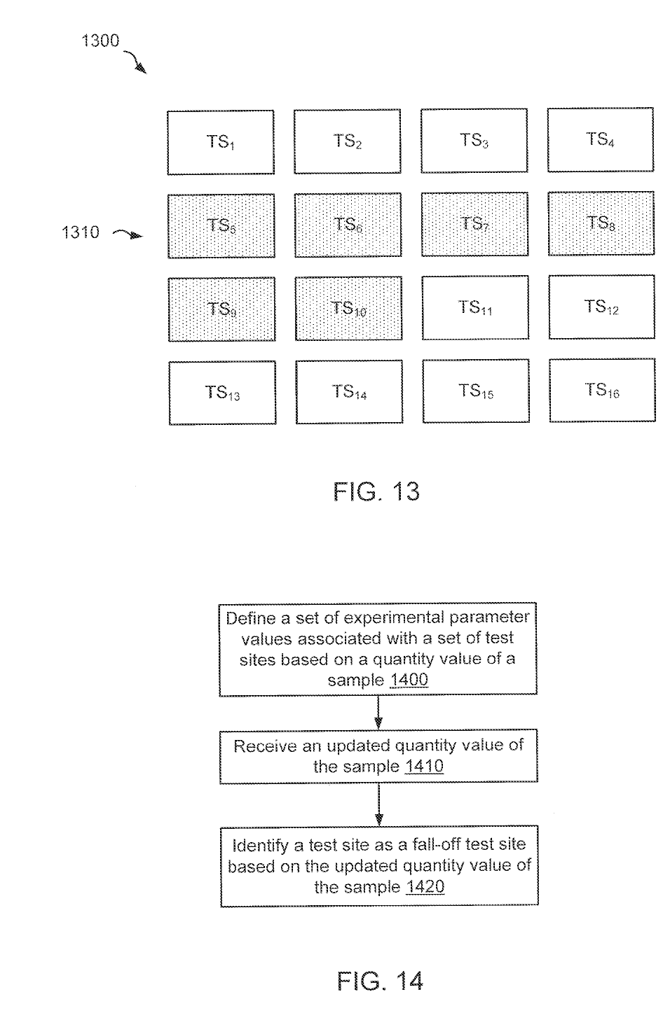

FIG. 13 is a schematic block diagram that illustrates a matrix of test sites 1300 of a testing substrate, according to an embodiment. Specifically, the matrix of test sites 1300 from the testing substrate includes 16 test sites in a 4×4 matrix. In this embodiment, several test sites 1310 (shown as shaded test site TS₅ through test site TS₁₀) have been selected by a user to each include a specified quantity of a sample based on an estimated quantity of the sample available in a physical inventory. In some embodiments, the test sites 1310 selected by the user based on the estimated quantity of the sample can be referred to as allocated test sites. The allocated test sites can be represented by one or more experimental parameter values.

When an actual quantity of the sample is different than the estimated quantity of the sample, a fall-off calculation can be performed by, for example, an experiment management engine to determine whether or not a sufficient quantity of the sample will be available for testing at each of the allocated test sites 1310. In some embodiments, the fall-off calculation can be part of an action that is performed in response to a condition being satisfied. In other words, the fall-off calculation can be implemented as a rule such as that shown in FIG. 2. In this case, the condition can be a lower actual quantity of sample than the estimated quantity of the sample. In some embodiments, the estimated quantity of a sample can be different than an actual quantity of sample because some of the sample can be destroyed during storage or during preparation of the sample for testing on a testing substrate, some of the actual sample may not be viable, or more sample per test site is needed than estimated.

For example, the allocated test sites 1310 can be selected to each contain cells of a sample (e.g., cells of a sample to be tested at a test device) based on an estimated quantity of cells of the sample available for testing. The estimated quantity of cells of the sample can be retrieved from an inventory database. If an actual quantity of available cells of the sample is half of the estimated quantity of available cells used to determine the allocated test sites 1310, half of the allocated test sites 1310 can be identified as fall-off test sites. Fall-off test sites are test sites that will not include any of the sample cells because the quantity of available cells is less than estimated. In other words, the quantity of samples cells will be insufficient to fill the fall-off test sites. In this case, test sites TS₈ through TS₁₀, for example, can be designated as fall-off test sites, and test sites TS₅ through TS₇ can be referred to as remaining test sites.

An experiment file can be defined (e.g., automatically defined) based on the remaining test sites (without the fall-off test sites) rather than based on the original allocated test sites. Specifically, experimental parameter values defining the test sites to be tested at the test device can identify the remaining test sites as valid test sites. Accordingly, a test device configured to perform a testing procedure based on the experimental parameter values included in the experiment file will test the sample included in the remaining test sites (and will not test the empty fall-off test sites unless a different sample is placed in the fall-off test sites).

In some embodiments, an experiment management engine can be configured to decrease an amount of a sample for each allocated test site and/or decrease a number of allocated test sites (remove fall-off test sites) when an actual quantity of the sample is less than an estimated quantity of the sample. In some embodiments, the actions performed by the experiment management engine during a fall-off calculation can be determined base a preference of a user (e.g., a preference of a user implemented in a rule). In some embodiments, an experiment management engine can be configured so that a user can manually override a fall-off calculation and/or an action performed by the experiment management engine based on a fall-off calculation. In some embodiments, an experiment management engine can be configured so that a user can undo one or more actions performed by the experiment management engine based on a fall-off calculation.

In some embodiments, a fall-off calculation can be performed any time during an experiment. For example, in some embodiments, a fall-off calculation can be triggered in accordance with a portion of a workflow. In some embodiments, a fall-off calculation can be manually triggered by a user during preparation of a test substance or when designing a portion of an experimental layout.

FIG. 14 is a flowchart that illustrates a method for performing a fall-off calculation, according to an embodiment. As shown in FIG. 14, a set of experimental parameter values associated with a set of test sites based on a quantity value of a sample at 1400. The quantity value of the sample can be an estimated quantity value and can be determined based on inventory information related to the sample and included in an inventory database.

An updated quantity value of the sample is received at 1410. The updated quantity value can be an actual quantity value of the sample determined during preparation of the sample for testing in a testing substrate. In some embodiments, the quantity of the sample can be updated because some of the sample can be destroyed during storage when more sample per test site is needed than estimated.

A test site is identified as a fall-off test site based on the updated quantity value of the sample at 1420. The fall-off test site can be determined based on a fall-off calculation. In some embodiments, the fall-off calculation can be implemented in a rule executed by an experiment management engine. In some embodiments, a fall-off calculation can be triggered manually by a user or automatically by the experiment management engine in response to a condition being satisfied.

FIG. 15 is a screenshot of a graphical user interface 1580 related to database management, according to an embodiment. The graphical user interface 1580 can be configured to enable a user to manage one or more databases such as databases 245 shown in FIG. 2. The graphical user interface 1580 can be associated with an inventory management module such as inventory management module 212 shown in FIG. 2. In this embodiment, the graphical user interface 1580 includes an experimental design window 1502, an administrative window 1504 and a pivot table display 1506. The graphical user interface 1580 also includes a reports window 1508 and a materials window 1510. Each of the windows may be activated (or accessed) by a mouse over click of a tab (or other type of link) associated with the window. Upon activating the tabs, relevant information can be displayed to (e.g., accessed by) the user in the window. In some embodiments, the tabs and windows can collectively be referred to as a tabs.

The experimental design window 1502 (when selected/activated) can provide (e.g., can display) links to layouts of experiments (e.g., portions of experiment templates) stored in one or more databases (e.g., databases 245 shown in FIG. 2). These links may be used to view the stored layouts of the experiments. Further, experimental design window 1502 (when selected/activated) can provide links for creating new experiments and designs. The experimental design window 1502 can also include functions that can be used by the user to copy an existing layout and/or for creating a new layout.

The administrative window 1504 can include functions that can be used by a user to perform administrative functions such as modifying and/or updating the information stored in database 106. For example, administrative window 1504 can provide links for editing or adding vendor information, inventory storage locations, experiment keywords, material definitions, material classes, sample definition, donor of the sample, and so forth. Administrative window 1504 (when selected/activated) also can be used by the user to modify meta-data information provided by the user related to the materials.

Pivot table display 1506 can display the information related to different materials stored in databases such as those shown in FIG. 2. Pivot table display 1506 can be configured to include a plurality of rows such as a row 1512 and a plurality of columns such as a column 1514. Each row can specify a material and details related to the material. Each column can specify different parameters associated with a material. For example, as shown, for each material information such as product name, catalog number, item type, item class vendor, color, size, and the like is specified. In this embodiment, the item type can include information related to whether the material is an antibody, a fluorochrome, a modulator, a general lab supply material and the like. Similarly, material class can include information related to whether the material is extracellular, intracellular, a buffer solution, a secondary solution and so forth. In addition, pivot table display 1506 may have different tabs (as shown) that can be selected to activate or obtain access to functions such as ‘view’, ‘edit’, and ‘new’ for managing the information displayed. The functions may be activated, for example, by a mouse over click of the tabs. In an embodiment of the invention, pivot table display 1506 may be a graphical user interface.

In accordance with various embodiments of the invention, materials window 1510 can be configured to include links for material receipt and usage. Materials window 1510 can also include links to administrative window 1504, which can be used to define new materials, new material types and classes. Reports window 1508 can be used by the user to generate different reports providing information such as status of the current inventory, usage of different materials, and any other customized report.

The different materials can be classified as, for example, biological samples, modulators, and/or stains used in the experiment. Administrative window 1504 enables the user to manage the inventory based on the classification of the materials. In some embodiments, as shown in FIG. 15, administrative window 1504 may have different sub-windows such as an administrative general window 1516, an administrative materials window 1518, and an administrative samples window 1520 that can include functions related to management of the information according to the classification of the materials.

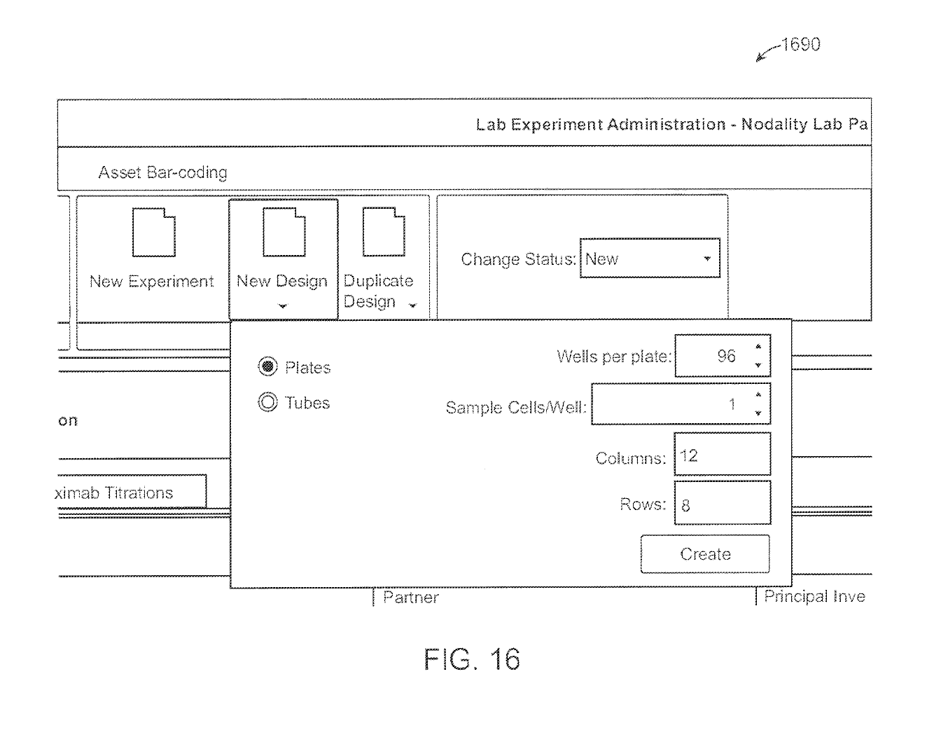

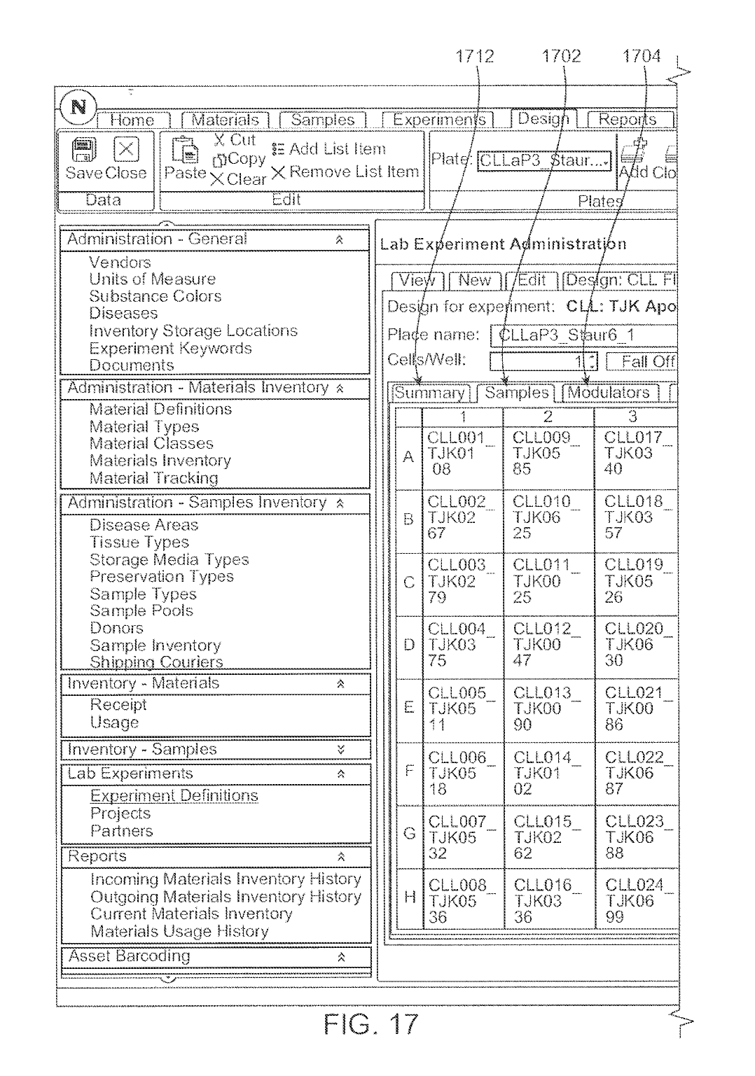

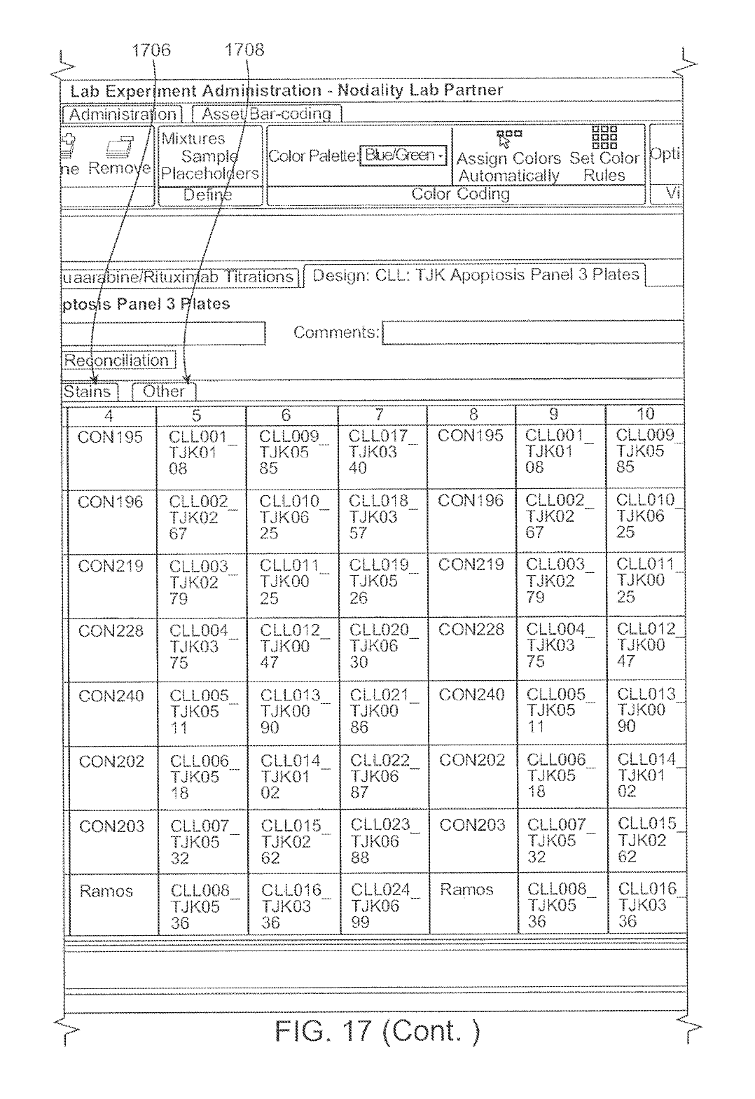

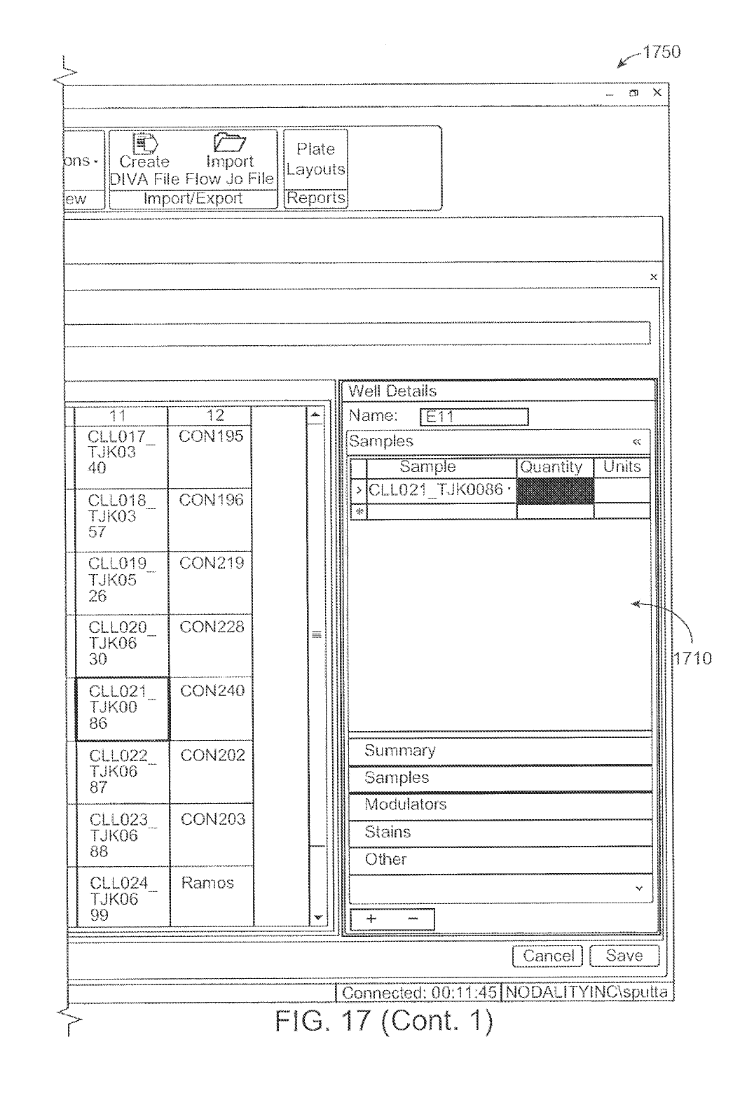

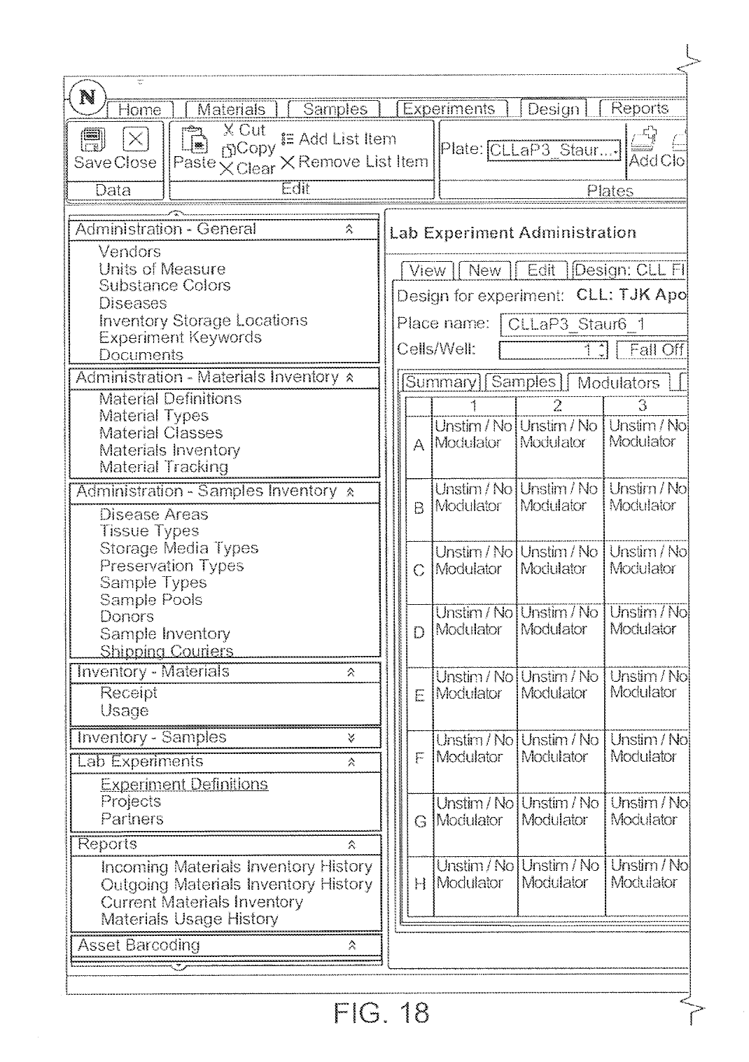

FIG. 16 is a screenshot of a graphical user interface 1690 related to experimental design, according to an embodiment. Graphical user interface 1690 can be used by a user to create a design for the experiment. Graphical user interface 1690 as shown can be used by the user to select between different options such as plates or tubes for an experimental layout. The graphical user interface 1690 can be associated with a design and plate layout generator module portion of the experimental module 222 shown in FIG. 2. Graphical user interface 1690 can also provide different experimental parameter value options for the layout design such as total number of wells per plate, total number of rows and columns, and so forth. For example, a plate having 96 wells can be selected as a layout. The graphical user interface 1690 can also display other experimental designs stored in one or more databases such as those shown in FIG. 2. The user can retrieve the other experimental designs from databases via the graphical user interface 1690. Depending on the selection made by the user on the graphical user interface 1690, the layout of the plate or tube can be displayed to the user in separate graphical user interface such as that described in connection with FIG. 17. The separate graphical user interface can be used by the user to fill content for each of the wells in the plate. In this embodiment, filling content in each well can refer to associating relevant materials and information with each well.

FIG. 17 is a screen shot of a graphical user interface 1750 related to experimental design, according to an embodiment. The graphical user interface 1750 can include a representation of plate having 96 wells. As shown in FIG. 17, the graphical user interface 1750 can have multiple windows (which can each be activated through selection of a tab) such as a sample window 1702, a modulator window 1704, a stain window 1706, and an others window 1708. The graphical user interface 1750 can also have a place 1710 for providing information about each wells in the layout. The graphical user interface 1750 can be associated with a design and plate layout generator module portion of the experimental module 222 shown in FIG. 2

Sample window 1702 can be configured to graphically represent the layout of the plate and can be used by the user to add biological samples to each well from a database (such as one of the databases shown in FIG. 2). Place 1710 can be configured to display information related to a selected well and can be used by the user to select and fill the biological sample in the selected well. In some embodiments, the user may select multiple wells simultaneously and these wells may be filled with same biological samples. Modulator window 1704 can be configured to display the plate layout filled with biological samples and can be used by the user to add modulators to each well from one or more databases (such as those shown in FIG. 2). Similarly, stain window 1706 can be configured to display the plate layout with each well being filled with the biological samples and the modulators. Stain window 1706 can be used by the user to add stains to each well. Others window 1708 can be used by the user to provide meta-data associated with each well. Meta-data can include, for example, information such as name of the patient, quantity of the biological sample present in the well, type of disease, name of the vendor providing the material, timestamp and so forth.

In accordance with some embodiments, the layout can then saved to a database (such as one or more of the databases shown in FIG. 2). Further, graphical user interface 1750 (export button) can be used by the user to export the layout in a format suitable for use with a software application used in the experiment. For example, the plate layout can be exported as an XML format that is compatible with DIVA software, with metadata stored in the header file.

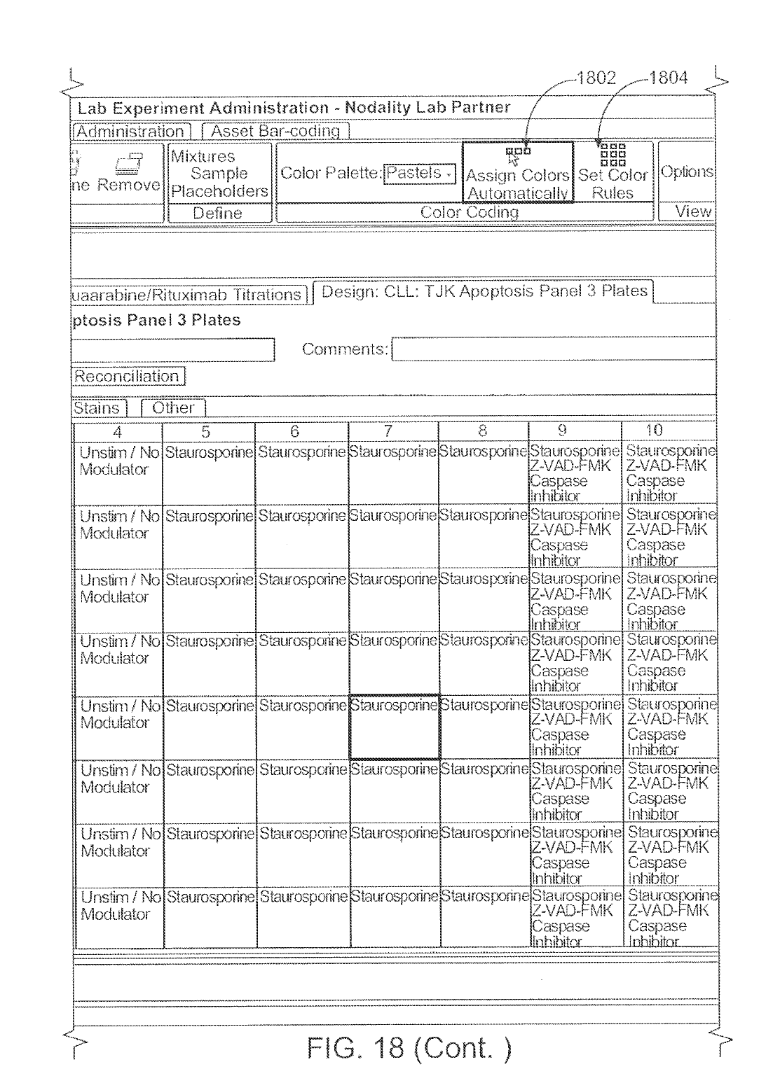

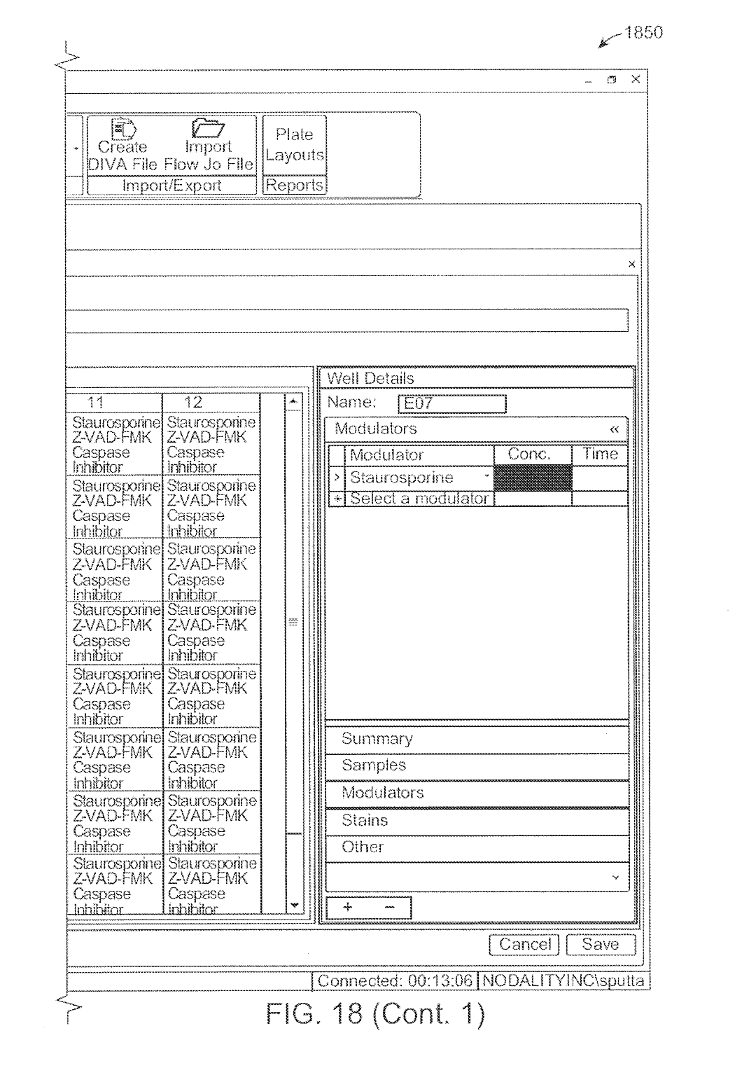

In some embodiments, the graphic user interface 1750 can also be configured to include a summary window 1712. Summary window 1712 can be configured to display the plate layout with complete information related to each well. In other words, information related to specific biological sample, modulators and detection elements that are added to each well can be displayed. In some embodiments, the graphical user interface 1750 can be used by the user to color code each well (with an indicator) in the plate layout based on the content of the well. This functionality is described in connection with FIG. 18.

FIG. 18 is a screenshot of a graphical user interface 1850 illustrating a color code feature, according to an embodiment. As shown, each well in the plate may be color coded based on the content of the well. An Assign Colors Automatically button 1802 and/or Set Color Rules button 1804 of graphical user interface 1850 can be used by the user to select a color scheme that may be applied to one or more wells. For example, wells having the same biological samples and modulators may be color coded with the same color or wells having the same quantity of biological samples may be color coded with the same color. The color coding provides the user visual aid during the physical experimentation process. In some embodiments, another type of indicator, such as a pattern, can be applied in place of or in addition to the color coding. The graphical user interface 1850 can be associated with a design and plate layout generator module portion of the experimental module 222 shown in FIG. 2

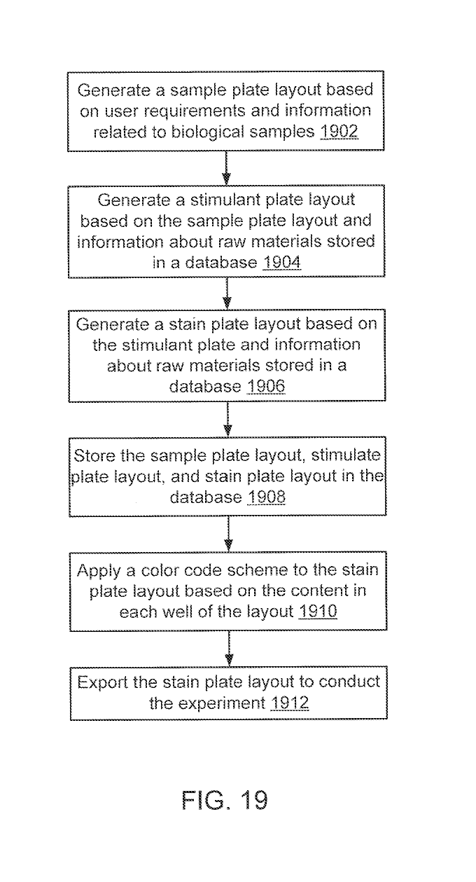

FIG. 19 is a flowchart that illustrates a method for designing an experiment, according to an embodiment. The design of the experiment can be generated with the aid of, for example, an experiment management engine (e.g., experiment management engine 220 shown in FIG. 2). As shown in FIG. 19, a sample plate layout can be generated using a layout generator (e.g., a design and plate layout generator module), at 1902. The sample plate layout can have multiple wells and information related to one or more biological samples to be filled in the wells. The information related to the biological samples can be stored in a database such as databases 245 shown in FIG. 2.

A modulator plate layout can be generated based on the sample plate layout and the information related to different modulators available in the database, at 1904. In other words, modulators are added to biological samples present in each well and the modulator plate layout is generated.

A stain plate layout can be generated based on the modulator plate layout and information related to different stains available in the database at 1906. Accordingly, the stain plate layout can have wells containing test substances that can include the biological samples, the modulators and the stains.

The sample plate layout, the modulator plate layout and the stain plate layout can be stored in the database, at 1908. A color code scheme is applied to the stain plate layout based on the content in each well present in the layout, at 1910. The stain plate layout can be exported to conduct the experiment, at 1912. The stain plate layout may be exported in a format that is compatible with a software application used for conducting the experiment. For example, the stain plate layout may be exported to DIVA software for use with a flow cytometer.

The above described systems (e.g., experiment system 100 shown in FIG. 1) and methods are further explained in conjunction with the following example. Herein, the experiment system can be used to design a flow cytometry experiment to study the effect of IFN-α, IFN-γ, IL-27 and IL-6 on expression of phosphorylated Stat1 (p-Stat1), phosphorylated Stat3 (p-Stat3), phosphorylated Stat5 (p-Stat5) and phosphorylated ERK (p-ERK) during acute myeloid leukemia (AML) disease progression.

The experimental design can be created using, for example, a first graphical user interface (e.g., the graphical user interface 1690 shown in FIG. 16). The first graphical user interface can be associated with a design and plate layout generation module. A 96 well plate format comprising 8 rows and 12 columns can be selected via the first graphical user interface. The rows can be labeled sequentially as A, B, C and so forth. The columns can be numbered sequentially as 1, 2, 3 and so forth.

Once the format is selected, the format can be displayed to the user via, for example, a second graphical user interface (e.g., graphical user interface 1750 shown in FIG. 17). The second graphical user interface can be associated with the design and layout generation module. The user can use the second graphical user interface to enter information related to the materials and to each of the 96 wells of the layout. Rows B, D, F, and H can be used as duplicates of rows A, C, E and G respectively. The information related to availability and usage of the materials such as IFN-α, IFN-γ, IL-27, IL6, phosphorylated Stat1 (p-Stat1), phosphorylated Stat3 (p-Stat3), phosphorylated Stat5 (p-Stat5) and phosphorylated ERK (p-ERK) is viewed by the user using, for example, a third graphical user interface (e.g., graphical user interface 1580 shown in FIG. 15).

A sample window of, for example, the second graphical user interface can be used to view the 96 well plate layout. Bone marrow derived monocytes (BMMC) are obtained from patients diagnosed with AML and the information can be stored in a database (such as the databases shown in FIG. 2). BMMC derived from a healthy donor can be used as the negative control. Wells A1-A4 and B1-B4 of the plate layout can be selected, and information related to BMMC from patient 1 can be entered. The information can include the name of the patient, type of the sample, volume of the sample (200 μL) and stage of the disease. This procedure can be repeated for BMMC from patients 2 to 11. To wells G9-G12 and H9-H12 information related to the negative control is entered.

In order to study the effect of four different modulators, IFN-α, IFN-γ, IL-27 and IL-6, on protein expression using flow cytometry, 4 modulator plate layouts can be generated using the plate layout. Each modulator plate layout can be specific for one modulator. The modulator window can be used to view the sample plate layout and enter information related to the modulators. For the IFN-α modulator plate layout, wells A1-A2, A5-A6, A9-A10 and so on till row H, can be selected and information related to IFN-α can be entered from a database of the inventory management module (e.g., inventory database 272 shown in FIG. 2). The information entered included volume of the sample (50 μL), name of the modulator, volume of the modulator (10 μL), catalog number of the modulator, type of the modulator, class of the modulator, vendor of the modulator, color of the modulator, size of the modulator and units of measurement of the modulator. Wells A3-A4, A7-A8, A11-A12 and so on till row H serve as negative control for the modulator treatment. This procedure can be repeated for all the other modulators giving rise to four modulator plate layouts.

In order to study the effect of each of the four modulators on the expression of four proteins, namely p-Stat1, p-Stat3, p-Stat5 and p-ERK using flow cytometry, 16 stain plate layouts can be generated using the four modulator plate layouts. Each stain plate layout can be specific for a combination of a modulator and a stain. The stain window can be used to view the plate layout and enter information related to the stains. For the stain plate layout specific for the combination of IFN-α and p-Stat1, wells A1, A3, A5, A7, A9, A11 and so on till row H of the IFN-α modulator plate layout, are selected and information related to the stain Cy3-conjugated goat anti-pStat1 antibody, is entered from the database of the inventory management module. The information entered included volume of the sample/modulator mixture (15 μL), name of the stain, volume of the stain (10 μL), catalog number of the stain, type of the stain, class of the stain, vendor of the stain, color of the stain, size of the stain and units of measurement of the stain. Wells A2, A4, A6, A8, A10, A12 and so on till row H serves as negative control for the staining procedure. This procedure can be repeated for all the other stains giving rise to 4 stain plates per modulator plate and 16 stain plates per sample plate. The stain plate layouts can be used to conduct the flow cytometry experiment.

The experiment system (e.g., experiment system 100 shown in FIG. 1) described above has a number of advantages. The interactive nature of the experiment system can be used by a user to plan the material needed, on-hand and used in an experiment. The experiment system can facilitate a user in generating a layout for the experiment and filling relevant material in each well of the layout. The layout generated can be stored and can be used while designing new experiment. This can increase the efficiency of processing associated with an experiment in a desirable fashion. Further, the layout generated using the experiment system can be exported (in a desirable fashion) to software applications which are used to carry out the experiments. Accordingly, use of the experiment system can result in a desirable increase in overall efficiency of conducting experiments. Furthermore, the graphical user interfaces of the experiment system can be used by the user to visualize a plate with multiple wells and the content in each well.

Other advantages that can be realized through the use of the experiment system include a relative reduction in low-value-added transactional activities and/or compatibility across platforms (e.g., test devices from different vendors). The experiment system can also provide relatively wide (and easy) access to filtered and/or structured information that can be specific (down to the cell-level). The experiment system can also assist a user making decisions related to experiments with a desirable level of quality, speed, and/or scalability. The experiment system can assist in processing test substances within a regulated (e.g., audited) environment.

The experiment system can be used to design relatively large scale experiments that could not have been previously achieved in a desirable fashion (with relatively few data entry errors and relatively rapid analytics). For example, the experiment system can facilitate a user in processing (e.g., running) many (e.g., 50 or less, 75, 100, 200, 250, 500, 1,000, 2,000, 2,500 or more) plates per experiment. In some embodiments, the many plates can be associated with a single test device such as a flow cytometry testing device. In some embodiments, the experiment system can be used by the user to process many (e.g., 10, 15, 25, 40, 50, 75, 100, 150, 200, 250) plates per week. In some embodiments, the experiment system can be used by a user to process experiments with, for example, 35 patients, using 150 different conditions (modulator/stain combos) to be performed in less than one month, 3 weeks, 2 weeks or 1 week. In some embodiments, the experiment system can be used by a user to process experiments with 125 patients, using 35 different conditions (modulator/stain combos) to be performed in less than one month (e.g., 3 weeks, 2 weeks, 1 week).

FIG. 20 is a schematic diagram that illustrates a visualization module 2050 of an experiment management engine 2020 configured to trigger display of values 36 within a user interface 2070, according to an embodiment. As shown in FIG. 20, the values 36 include value₁ through value₉, and each of the values 36 are displayed within a data visualization region 2084 (or regions) of the user interface 2070 in a visualization layout 38 (e.g., a display layout, a visual layout). The arrangement of the values 36 within the visualization region 2084 define at least a portion of the visualization layout 38. In some embodiments, the data visualization region 2084 can be, or can include, a display such as a liquid crystal display (LCD) display, a set of light emitting diodes (LEDs), and/or so forth, where the visualization layout 38 can be statically and/or dynamically displayed. In some embodiments, one or more of the functions associated with the visualization module 2050 can be included in one or more different modules (not shown).

In some embodiments, the visualization layout 38 (e.g., an arrangement of the visualization layout 38) can be and/or can include, for example, a form in which the values 36 are represented, an orientation (e.g., x-y location) of the values 36 within the data visualization region 2084 and/or with respect other of the values 36, a timing with which the values 36 are displayed, elements (e.g., variables, shapes, placeholders) where the values 36 can be displayed, elements (e.g., graphic elements, spacing elements) that may or may not be displayed, and/or so forth. In some embodiments, the visualization layout 38 can be associated with (e.g., can include) one or more procedures (e.g., algorithms) that can be used to calculate and/or update values displayed within the visualization layout 38. For example, one or more of the values 36 included in the visualization layout 38 can be updated based on a procedure, and the updated value(s) can be displayed in the visualization layout 38.

In some embodiments, one or more of the values 36 displayed within the visualization layout 38 can be updated based on processing performed at the experiment management engine 2020. For example, the experiment management engine 2020 can define an instruction, in response to a request from a user, that can modify (e.g., trigger modification of) the output data used to define the values 36. In some embodiments, for example, output data using to define one or more of the values 36 can be modified (e.g., recalculated) based on data added to the output data by the experiment management engine 2020 (based on an instruction). The modified value(s) 36 can be displayed (and can replace value(s) 36 already being displayed) within the visualization layout 38. In some embodiments, output data using to define one or more of the values 36 can be, for example, modified (e.g., recalculated) based on a portion of the output data parsed from the output data in response to a gating analysis performed at the experiment management engine 2020. The modified value(s) 36 can be displayed (and can replace value(s) 36 already being displayed) within the visualization layout 38. In some embodiments, one or more of the values can be changed (e.g., updated) directly without changing the output data used to define the values. For example, one or more of the values 36 can be changed based on a procedure, which is used for calculating the value(s) 36, being changed.

In some embodiments, the visualization layout 38 can be defined by one or more visualization layout parameter values. In other words, the visualization layout 38 such as the orientation of the values 36, the procedures used to calculate values for display in the visualization layout 38, etc. can be defined by the visualization layout parameter value(s). In some embodiments, at least one or more portions of the visualization layout 38 can be defined by, for example, an experiment file. In other words, one or more visualization layout parameter values can be included in an experiment file defined during, for example, a preparation phase, a processing phase, and/or an analysis phase of an experiment. For example, one or more visualization layout parameter values can be included in a experiment file based on an experiment template (e.g., a cocktail) included in the experiment file. In some embodiments, one or more visualization layout parameter values can be included in (e.g., can be defined within, can be integrated within) an experiment template.

As shown in FIG. 20, value₁ through value₄ are displayed so that they define a heat map 32, and value₇ through value₉ are displayed within a graph 34. In this embodiment, the heat map 32 and the graph 34 define at least some portions of the visualization layout 38. Also as shown in FIG. 20, value₅ and value₆ are displayed within the data visualization region 2084 to the right of the heat map 32 and the graph 34. In some embodiments, a heat map (such as heat map 32 shown in FIG. 20) can be a graphical representation where values are represented in, for example, a two-dimensional map as colors, shapes, and/or so forth that correspond with the magnitudes of the values so that spatial relationships between the values and their magnitudes can be comprehended by a user in a desirable fashion. Heat maps can be used in, for example, molecular biology to represent the expression levels of proteins across a number of comparable samples (e.g. cells in different states, samples from different patients) as they are obtained from experiments such as from DNA microarrays.

The visualization layout 38 can be defined (e.g., customized, modified) using user interface controls 2082. The user interface controls 2082 can trigger processing at the visualization module 2050 so that the visualization layout 38 (e.g., visualization layout parameter values of the visualization layout 38) can be defined. The user interface controls 2082 can include, for example, a context menu, a control/selection screen, a filtering control (e.g., a pre-filtering control), a category selection control, a button that can be dragged and/or dropped, a pivot table control, a graph control, a range selection control, and/or so forth. For example, a portion of the graph 34 (e.g., x-axis scaling) can be defined in response to an interaction of a user with a graph control included in the user interface controls 2082. In some embodiments, the user interface controls 2082 can include physical buttons that can be actuated and/or controls that can be displayed within a display.

In some embodiments, one or more visualization layout parameter value(s) can be stored at, for example, memory 2030 (and/or a remote memory (not shown)) of the experiment management engine 2020. Accordingly, the visualization layout parameter value(s) can be retrieved by and used by the visualization module 2050 to define a visualization layout, such as visualization layout 38, for display in the data visualization region 2084.

In some embodiments, a visualization layout, such as visualization layout 38, can function as a visualization layout template. For example, a first set of output data can be used to define one or more values that can be displayed within a visualization layout template. The visualization layout template can be defined based on one or more visualization layout parameter values that can be retrieved from a memory. A second set of output data can be used to define one or more values for display within the visualization layout template. In some embodiments, the first set of output data can have portions that overlap with the second set of output data. For example, the second set of output data can be a subset (or superset) of the first set of output data defined using, for example, a gating analysis performed at the experiment management engine 2020. In some embodiments, the first set of output data can be mutually exclusive from the second set of output data.

In some embodiments, one or more visualization layouts (e.g., template visualization layouts) can be stored in and accessed from a library of visualization layouts. In some embodiments, one or more of the visualization layouts in the library of visualization layouts can be defined by a user via the user interface controls 2082. The visualization layouts can be stored such that they can be accessed by multiple users (e.g., multiple users having the proper credentials). In some embodiments, one or more portions of a visualization layout can be automatically defined based on a user preference, for example, stored in the memory 2030.

In some embodiments, the one or more visualization layouts (e.g., parameter value(s) defining visualization layout(s)) can be exported and/or imported. For example, one or more parameter values defining a visualization layout can be exported to a module and/or a device using a layout export module (not shown). In some embodiments, for example, one or more parameter values defining a visualization layout can be imported to a module and/or a device using a layout import module (not shown). In some embodiments, one or more functions associated with the layout import module and/or the layout export module can be included in the visualization module 2050 and/or a different module (not shown).

One or more of the values 36 can be defined based on output data received from a test device 2040 such as a flow cytometer. For example, one or more of the values 36 can be calculated based on several data values (e.g., test data values) included in output data from a test device. In some embodiments, one or more of the values can correspond with a data value from the output data (without mathematical manipulation of the data value from the output data). In other words, one or more of the values 36 included in the visualization layout 38 can be raw output data from, for example, a flow cytometer.

In some embodiments, the output data can be processed using a data extraction process. In some embodiments, data extraction can include receiving (e.g., retrieving) data (e.g., unstructured data, binary data) from of a data source, such test device 2040, for further data processing or data storage (data migration). In some embodiments, data extraction can include transforming the data and/or adding metadata to the output data. The output data can be stored in, for example, a data library (e.g., a data library stored in the memory 2030 and/or a remote memory (not shown)) so that the output data can be processed (e.g., accessed, manipulated). Data extraction can be performed using a data import module (not shown), which can be included in, for example, the experiment management engine 2020. In some embodiments, output data that has been extracted can be exported to, for example, another module or device using a data export module (not shown), which can be included in, for example, the experiment management engine 2020. More details related to user interface controls, data extraction, visualization layouts, and so forth are described in co-pending U.S. Provisional Patent Application No. 61/079,537, filed on Jul. 10, 2008, entitled “Method and System for Data Extraction and Visualization of Multi-Parametric Data,” which has been incorporated by reference herein in its entirety.

FIG. 21 is a schematic diagram that illustrates a method for displaying output data within a visualization layout, according to an embodiment. As shown in FIG. 21, output data related to an experiment performed at a flow cytometer is received, at 2110. In some embodiments, the output data can be stored in a memory where the output data can be, for example, accessed.

A set of parameter values defining a visualization layout of a set of values defined based on the output data is received, at 2120. In some embodiments, one or more of the set of values can be calculated based on the output data. In some embodiments, the set of parameter values can be defined in response to one or more user interface controls being triggered (e.g., actuated), for example, by a user. In some embodiments, the set of parameter values can be defined via a visualization module. In some embodiments, the visualization layout can be a template visualization layout from a library of visualization layouts. Accordingly, the set of parameter values can be retrieved from the library of visualization layouts.

Display of the set of values within the visualization layout is triggered based on the set of parameter values, at 2130. In some embodiments, the display of the set of values within the visualization layout can be triggered by a visualization module.

The output data is modified in response to an instruction, at 2140. In some embodiments, the instruction can be defined at an experiment management engine. For example, the instruction can be related to a gating analysis or other type of statistical analysis performed at the experiment management module.

A value from the set of parameter values displayed within the visualization layout is updated in response to the output data being modified, at 2150. In some embodiments, the value can be, for example, recalculated based on the modified output data. In some alternative embodiments, a value within a visualization layout can be updated without modifying output data used to define the value. In some alternative embodiments, the visualization layout can be dynamically updated, for example, in response to an instruction from a user, a change in a value displayed within the visualization layout, a change in output data used to define a value displayed in the visualization layout, and/or so forth.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

In some embodiments, an experiment management engine and/or any portion of the embodiments described herein can be executed at (e.g., implemented on) a computer. In some embodiments, a computer can be used by to operate various instrumentation, liquid handling equipment and/or analysis software. The computer can have any type of computer platform such as a workstation, a wireless device, a wired device, a mobile device (e.g., a PDA), a personal computer, a server, and/or any other present or future electronic device and/or computer. The computer can include, for example, components such as a processor, an operating system, a system memory, a memory storage device, input-output controllers, input-output devices, and/or display devices. Display devices can be configured to display visual information that may be may be logically and/or physically organized as an array of pixels. A GUI controller may also be included that may include any of a variety of known or future software programs for providing graphical input and output interfaces such as for instance GUI's. For example, GUI's may provide one or more graphical representations to a user, and also be enabled to process the user inputs via GUI's using means of selection or input known to those of ordinary skill in the related art. For example, see U.S. Ser. No. 61/048,657, which is incorporated by reference in its entirety.

A computer can have many possible configurations of components and some components that may typically be included in a computer are not shown, such as a cache a memory, a data backup unit, and/or many other devices. The processor can be a commercially available processor such as an Itanium® or Pentium® processor made by Intel Corporation, a SPARC® processor made by Sun Microsystems, an Athalon™ or Opteron™ processor made by AMD corporation, or it may be one of other processors that are or will become available. Some embodiments of the processor may also include what are referred to as Multi-core processors and/or be enabled to employ parallel processing technology in a single or multi-core configuration. For example, a multi-core architecture typically can include two or more processor such as “execution cores.” In the present example, each execution core may perform as an independent processor that enables parallel execution of multiple threads. In addition, the processor may be configured in what is generally referred to as 32 or 64 bit architectures, or other architectural configurations now known or that may be developed in the future.

The processor executes operating system, which may be, for example, a Windows®-type operating system (such as Windows® XP) from the Microsoft Corporation; the Mac OS X operating system from Apple Computer Corp. (such as 7.5 Mac OS X v10.4 “Tiger” or 7.6 Mac OS X v10.5 “Leopard” operating systems); a Unix® or Linux-type operating system available from many vendors or what is referred to as an open source; another or a future operating system; or some combination thereof. In some embodiments, the operating system can be configured to interface with firmware and hardware in various manners, and facilitate a processor in coordinating and executing the functions of various computer programs that may be written in a variety of programming languages. The operating system can be configured to cooperate with the processor, coordinate and execute functions of the other components of computer. The operating system can also be configured to provide scheduling, input/output control, file and data management, memory management, and/or communication control and related services.

In some embodiments, a memory can be used in conjunction with the embodiments described herein. The memory may be any of a variety of known or future memory storage devices. Examples include any available random access memory (RAM), magnetic medium such as a resident hard disk or tape, an optical medium such as a read and write compact disc, or other memory storage device. Memory storage devices may be any of a variety of known or future devices, including a compact disk drive, a tape drive, a removable hard disk drive, USB or flash drive, or a diskette drive. Such types of memory storage devices can be configured to read from, and/or write to, a program storage medium (not shown) such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, can be stored in system memory and/or the program storage device used in conjunction with memory storage device.

In one embodiment, a method can include defining experimental parameter values associated with a plurality of test sites within a testing substrate based on a quantity value of a sample. The experimental parameter values can define at least a portion of an experimental plan associated with the sample. An updated quantity value of the sample can be received and a test site from the plurality of test sites can be identified as a fall-off test site based on the updated quantity value of the sample. In some embodiments, the method can be performed at a system that can include a physical inventory, a design management engine, and a user interface.

In some embodiments, the plurality of test sites can define an experimental layout within the testing substrate. The method can also include changing a status of the test site from an available status (or test status) to an unavailable status (non-test status) in response to the identifying. The method can also include modifying the experimental layout based on the plurality of test sites after the removing.

In some embodiments, the experimental layout can be configured for analysis by a flow cytometry device. In some embodiments, the experimental layout can be defined based on an experimental layout template retrieved from a template database. In some embodiments, the sample can be a biological sample. In some embodiments, the updated quantity value of the sample can be defined in response to a prompt triggered by a workflow. In some embodiments, the workflow can be defined based on a standard operating procedure.

In some embodiments, at least a portion of the experimental parameter values can be defined based on a pre-defined recipe. In some embodiments, the experimental parameter value can be defined based on an automatic unit conversion procedure. In some embodiments, at least one of the experimental parameter values represents a chemical composition.

In another embodiment, a method can include sending an indicator of an availability of a sample from a sample pool stored in a physical inventory. The sample can be included in the sample pool based on an attribute of the sample satisfying a condition associated with the sample pool. An indicator that the sample has been selected from the sample pool for analysis at a first test site included in an array of test sites can be received. A rule from a rule database based on an experimental parameter value associated with the first test site can be retrieved. The method can also include modifying at least one of the experimental parameter value associated with the first test site or an experimental parameter value associated with a second test site based on a condition within the rule being satisfied. In some embodiments, the method can be performed at a system that can include a physical inventory, a design management engine, and a user interface.

In some embodiments, the attribute of the sample can be a hidden attribute from a plurality of hidden attributes. In some embodiments, the attribute of the sample can be included in an experiment file associated with the first test site when a status of the attribute is changed from a hidden status to an unhidden status. In some embodiments, the sample pool can be a first sample pool, and the sample can be included in a second sample pool based on the attribute of the sample satisfying a condition associated with the second sample pool.

In some embodiments, the sample can be selected from the sample pool based on a scientific question associated with a clinical study. In some embodiments, the method can also include modifying an experimental layout associated with the array of test sites in response to the receiving. In some embodiments, the method can also include defining an experiment file based on the experimental parameter value associated with a first test site after the modifying. In some embodiments, the method can also include receiving an indicator that a portion of a workflow has been completed, at least one of the retrieving or the modifying is performed after the receiving of the indicator.

In yet another embodiment, a method can include receiving a first attribute associated with a substance selected for analysis at a test site from an array of test sites. A condition from a knowledge database based on the first attribute can be retrieved. A condition associated with a rule based on the first attribute can also be retrieved. The rule can be defined based on information included in a knowledge database. The method can also include sending a notification in response to a condition related to an interaction between the first attribute and a second attribute being satisfied. In some embodiments, the method can be performed at a system that can include a physical inventory, a design management engine, and a user interface.

In some embodiments, the knowledge database can be defined based on empirical data. In some embodiments, the method can also include modifying an experimental layout associated with the array of test sites in response to the condition being satisfied. In some embodiments, the method can also include sending an indicator that a sample within an inventory is available, and associating the sample with the test site, the attribute represents a chemical property of the sample.

In some embodiments, the first attribute can be associated with a first reagent included in the substance. The second attribute can be associated with a second reagent included in the substance. In some embodiments, the first attribute can be associated with a first reagent included in the substance. The second attribute can be associated with a sample included in the substance. In some embodiments, the substance can be a first substance and the test site can be a first test site. The second attribute can be associated with a second substance selected for analysis at a second test site from the array of test sites.

In some embodiments, the condition can be related to a chemical conflict. In some embodiments, the condition can be related to a detection conflict. In some embodiments, the condition can be related to an empirical finding stored in the knowledge database.

In yet another embodiment, a method can include producing a child prepared test substrate based on a parent prepared test substrate. An inventory identifier for the child prepared test substrate is defined in response to the producing. The inventory identifier for the child prepared test substrate can be different than an inventory identifier for the parent prepared test substrate. In some embodiments, the inventory identifier for the child prepared test substrate can be used to track the child prepared test substrate as an inventory item separate from the parent prepared test substrate. In some embodiments, the inventory identifier for the child prepared test substrate can be used to link data associated with the child prepared test substrate with data associated with the parent prepared test substrate. In some embodiments, the method can be performed at a system that can include a physical inventory, a design management engine, and a user interface.

In yet another embodiment, a method can include defining a set of indicator layers related to an experiment. In some embodiments, each indicator layer from the set of indicator layers can be associated with different portions of hierarchically related prepared test substrates. In some embodiments, the method can be performed at a system that can include a physical inventory, a design management engine, and a user interface.

In yet another embodiment, one or more processor-readable media storing code representing instructions that when executed by one or more processors cause the one or more processors to receive a plurality of data values related to an experiment executed at a flow cytometer. A display of at least one of the plurality of data values or a value calculated based on the plurality of data values within a customizable visualization layout can be triggered.

In some embodiments, the one or more processor-readable media can further store code representing instructions that when executed by the one or more processors cause the one or more processors to receive at least a portion of an experiment file defining at least a portion of the experiment. A portion of the customizable visualization layout can be defined based on at least a portion of the experiment file.

In some embodiments, the plurality of data values can be a first plurality of data values and the display can be triggered at a first time. The one or more processor-readable media can further store code representing instructions that when executed by the one or more processors cause the one or more processors to define a second plurality of data values including at least a portion of the first plurality of data values. At a second time, display of at least one of the second plurality of data values or a value calculated based on the second plurality of data values within the customizable visualization layout can be triggered.

In some embodiments, the plurality of data values can be a first plurality of data values and the display can be triggered at a first time. The one or more processor-readable media can further store code representing instructions that when executed by the one or more processors cause the one or more processors to receive a second plurality of data values mutually exclusive from the first plurality of data values. At a second time, display of at least one of the second plurality of data values or a value calculated based on the second plurality of data values within the customizable visualization layout can be triggered.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, one or more experiment management engines can be configured to manage multiple experiments simultaneously and/or serially. The multiple experiments can be executed at different locations via one or more client devices with user interfaces.

1. One or more processor-readable media storing code representing instructions that when executed by one or more processors cause the one or more processors to:
define experimental parameter values associated with a plurality of test sites within a testing substrate based on a quantity value of a sample, the experimental parameter values defining at least a portion of an experimental plan associated with the sample;
receive an updated quantity value of the sample; and
identify a test site from the plurality of test sites as a fall-off test site based on the updated quantity value of the sample.

2. The one or more processor-readable media of claim 1, wherein the plurality of test sites define an experimental layout within the testing substrate,
the one or more processor-readable media further storing code representing instructions that when executed by one or more processors cause the one or more processors to:
change a status of the test site from an available status to an unavailable status in response to the identifying; and
modify the experimental layout based on the plurality of test sites after the removing.

3. The one or more processor-readable media of claim 2, wherein the experimental layout is configured for analysis by a flow cytometry device.

4. The one or more processor-readable media of claim 2, wherein the experimental layout is defined based on an experimental layout template retrieved from a template database.

5. The one or more processor-readable media of claim 1, wherein the sample is a biological sample.

6. The one or more processor-readable media of claim 1, wherein the updated quantity value of the sample is defined in response to a prompt triggered by a workflow.

7. The one or more processor-readable media of claim 6, wherein the workflow is defined based on a standard operating procedure.

8. The one or more processor-readable media of claim 1, wherein at least a portion of the experimental parameter values are defined based on a pre-defined recipe.

9. The one or more processor-readable media of claim 1, wherein the experimental parameter value is defined based on an automatic unit conversion procedure.

10. The one or more processor-readable media of claim 1, wherein at least one of the experimental parameter values represents a chemical composition.

11. One or more processor-readable media storing code representing instructions that when executed by one or more processors cause the one or more processors to:
send an indicator of an availability of a sample from a sample pool stored in a physical inventory, the sample being included in the sample pool based on an attribute of the sample satisfying a condition associated with the sample pool;
receive an indicator that the sample has been selected from the sample pool for analysis at a first test site included in an array of test sites;
retrieve a rule from a rule database based on an experimental parameter value associated with the first test site; and
modify at least one of the experimental parameter value associated with the first test site or an experimental parameter value associated with a second test site based on a condition within the rule being satisfied.

12. The one or more processor-readable media of claim 11, wherein the attribute of the sample is a hidden attribute from a plurality of hidden attributes.

13. The one or more processor-readable media of claim 11, wherein the attribute of the sample is included in an experiment file associated with the first test site when a status of the attribute is changed from a hidden status to an unhidden status.

14. The one or more processor-readable media of claim 11, wherein the sample pool is a first sample pool, the sample is included in a second sample pool based on the attribute of the sample satisfying a condition associated with the second sample pool.

15. The one or more processor-readable media of claim 11, wherein the sample is selected from the sample pool based on a scientific question associated with a clinical study.

16. The one or more processor-readable media of claim 11, further storing code representing instructions that when executed by one or more processors cause the one or more processors to:
modify an experimental layout associated with the array of test sites in response to the receiving.

17. The one or more processor-readable media of claim 11, further storing code representing instructions that when executed by one or more processors cause the one or more processors to:
define an experiment file based on the experimental parameter value associated with a first test site after the modifying.

18. The one or more processor-readable media of claim 11, further storing code representing instructions that when executed by one or more processors cause the one or more processors to:
receive an indicator that a portion of a workflow has been completed, at least one of the retrieving or the modifying is performed after the receiving of the indicator.

19. One or more processor-readable media storing code representing instructions that when executed by one or more processors cause the one or more processors to:
receive a first attribute associated with a substance selected for analysis at a test site from an array of test sites;
retrieve a condition from a knowledge database based on the first attribute; and
retrieve a condition associated with a rule based on the first attribute, the rule being defined based on information included in a knowledge database; and
send a notification in response to a condition related to an interaction between the first attribute and a second attribute being satisfied.

20. The one or more processor-readable media of claim 19, further storing code representing instructions that when executed by one or more processors cause the one or more processors to:
modify an experimental layout associated with the array of test sites in response to the condition being satisfied.

21.-33. (canceled)
